(19) United States
(12) Patent Application Publication
(10) Pub. No.: US 2016/0140387 A1
(43) Pub. Date: May 19, 2016

(54) ELECTRONIC APPARATUS AND METHOD

(71) Applicant: Kabushiki Kaisha Toshiba, Tokyo (JP)

(72) Inventor: Chikashi Sugiura, Hamura Tokyo (JP)

(21) Appl. No.: 15/007,553

(22) Filed: Jan. 27, 2016

Related U.S. Application Data
(63) Continuation of application No. PCT/JP2013/078710, filed on Oct. 23, 2013.

(51) Int. Cl. G06K 9/00; G06F 3/0488; G06F 3/0354; G06K 9/22

(52) U.S. Cl. CPC G06K 9/00416; G06K 9/222; G06F 3/04883; G06F 3/03545

(57) ABSTRACT

According to one embodiment, a method includes displaying a document on a display; receiving at least one first stroke made on the document; determining a first handwriting candidate comprising first coordinates in response to a reception of the at least one first stroke, wherein the first coordinates are determined according to both a shape of the first handwriting candidate and an input position of the at least one first stroke; displaying the first handwriting candidate on the display; converting at least part of the first coordinate to generate second coordinates of the first handwriting candidate according to an input area of the document; and inputting the first handwriting candidate into the document according to the second coordinates, if the first handwriting candidate is selected.

### CROSS REFERENCE TO RELATED APPLICATIONS

This application is a Continuation Application of PCT Application No. PCT/JP2013/078710, filed Oct. 23, 2013, the entire contents of which are incorporated herein by reference.

### FIELD

Embodiments described herein relate generally to a technique for inputting a handwritten character string.

### BACKGROUND

In recent years, various types of electronic apparatuses such as a tablet computer, a notebook computer, a smartphone, and a PDA have been developed as those that can input a handwritten document.

Accordingly, a technique is desirable to allow the handwritten document to be easily created.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an appearance of an electronic apparatus of one of the embodiments.

FIG. 2 is a block diagram showing an example of cooperation between the electronic apparatus and another device.

FIG. 3 is an illustration showing an example of a handwritten document which is handwritten on a touchscreen.

FIG. 4 is a block diagram showing an example of time-series information which is a set of stroke data.

FIG. 5 is a block diagram showing an example of a system configuration of the electronic apparatus.

FIG. 6 is an illustration showing an example of a home screen displayed by the electronic apparatus.

FIG. 7 is an illustration showing an example of a notebook preview screen displayed by the electronic apparatus.

FIG. 8 is an illustration showing an example of a setting screen displayed by the electronic apparatus.

FIG. 9 is an illustration showing an example of a page edit screen displayed by the electronic apparatus.

FIG. 10 is an illustration showing an example of a search dialog displayed by the electronic apparatus.

FIG. 11 is a block diagram showing an example of a functional configuration of a handwriting note application program executed by the electronic apparatus.

FIG. 12 is a table showing an example of a data structure of a suggest feature table.

FIG. 13 is a table showing an example of a data structure of a suggest keyword table.

FIG. 14 is a flowchart showing an example of feature registration processing.

FIG. 15 is an illustration specifically explaining cumulative character recognition processing.

FIG. 16 is a flowchart showing an example of candidate display processing.

FIG. 17 is an illustration showing an example of a candidate display region in which a candidate of a character string is displayed.

FIG. 18 is an illustration showing an example of a handwritten input region that displays a character string selected by a user.

FIG. 19 is an illustration corresponding to FIG. 18 when a language of a character string handwritten by the user is Japanese.

FIG. 20 is an illustration corresponding to FIG. 19 when a language of a character string handwritten by the user is Japanese.

FIG. 21 is a flowchart showing an example of selected character string display processing.

FIG. 22 is an illustration showing an example when a selected character string cannot be displayed in the handwritten character input region.

FIG. 23 is an illustration further showing another example when a selected character string cannot be displayed in the handwritten character input region.

FIG. 24 is an illustration specifically explaining a first display example of a selected character string.

FIG. 25 is an illustration corresponding to FIG. 22 when a language of a character string handwritten by the user is Japanese.

FIG. 26 is an illustration corresponding to FIG. 24 when a language of a character string handwritten by the user is Japanese.

FIG. 27 is an illustration specifically explaining a second display example of a selected character string.

FIG. 28 is an illustration specifically explaining a position of a line-break portion of the second display example.

FIG. 29 is an illustration corresponding to FIG. 27 when a language of a character string handwritten by the user is Japanese.

FIG. 30 is an illustration specifically explaining a third display example of a selected character string.

FIG. 31 is an illustration corresponding to FIG. 30 when a language of a character string handwritten by the user is Japanese.

FIG. 32 is an illustration explaining a region in which a selected character string is displayed.

FIG. 33 is an illustration explaining a region at which a selected character string is displayed.

FIG. 34 is an illustration explaining a region at which a selected character string is displayed.

FIG. 35 is an illustration corresponding to FIG. 32 when a language of a character string handwritten by the user is Japanese.

FIG. 36 is an illustration corresponding to FIG. 33 when a language of a character string handwritten by the user is Japanese.

### DETAILED DESCRIPTION

Various embodiments will be described hereinafter with reference to the accompanying drawings. In general, according to one of the embodiments, a method includes displaying a document comprising handwriting on a display; receiving at least one first stroke made on the document; determining a first handwriting candidate comprising first coordinates in response to a reception of the at least one first stroke, wherein the first coordinates are determined according to both a shape of the first handwriting candidate and an input position of the at least one first stroke; displaying the first handwriting candidate on the display; converting at least part of the first coordinate to generate second coordinates of the first handwriting candidate according to an input area of the document; and inputting the first handwriting candidate into the document according to the second coordinates, if the first handwriting candidate is selected.

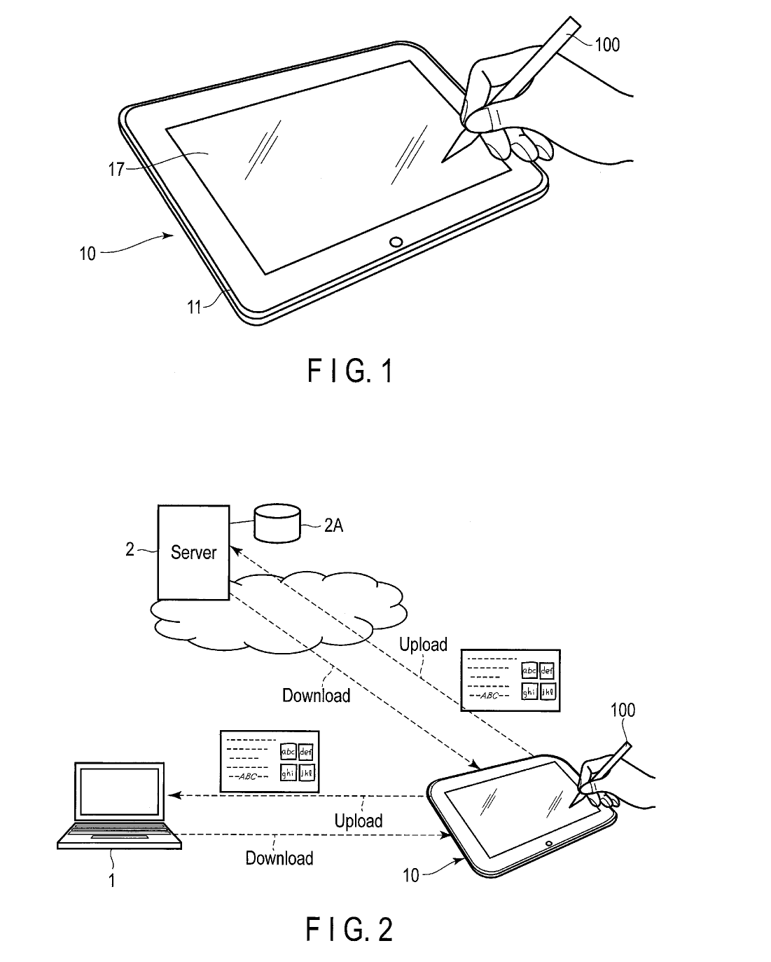

FIG. 1 is a perspective view showing an appearance of an electronic apparatus of one of the embodiments. The electronic apparatus is, for example, a stylus-based portable electronic apparatus capable of handwriting input with a stylus or a finger. The electronic apparatus can be implemented as a tablet computer, a notebook computer, a smartphone, a PDA, or the like. The electronic apparatus is implemented as a tablet computer 10 in the following explanations. The tablet computer 10 is a portable electronic apparatus called a tablet or slate computer, and its body 11 includes a housing shaped in a thin box.

A touchscreen display 17 is mounted on the body 11 so as to overlay an upper surface of the body 11. In the touchscreen display 17, a flat-panel display and a sensor configured to detect the contact position of a stylus or a finger on the screen of the flat-panel display are incorporated. The flat-panel display may be, for example, a liquid-crystal display (LCD). For example, a capacitive touchpanel, an electromagnetic induction type digitizer or the like can be used as the sensor. In the following explanations, both the two types of sensor, the digitizer and the touchpanel, are incorporated in the touchscreen display 17. For this reason, the touchscreen display 17 can also detect not only a touch operation on the screen with a finger, but also a touch operation on the screen with a stylus 100.

The stylus 100 may be, for example, a digitizer stylus (electromagnetic induction stylus). The user can also execute a handwriting input operation on the touchscreen display 17 with the stylus 100 (stylus input mode). In the stylus input mode, a locus of a motion of the stylus 100 on the screen, i.e., a stroke handwritten by the handwriting input operation is obtained, and plural strokes input by handwriting are thereby displayed on the screen. The locus of the motion of the stylus 100 formed while the stylus 100 is in touch with the screen corresponds to one stroke. Plural strokes form characters, symbols and the like. A set of multiple strokes corresponding to a handwritten character, a handwritten figure, a handwritten table and the like constitutes a handwritten document.

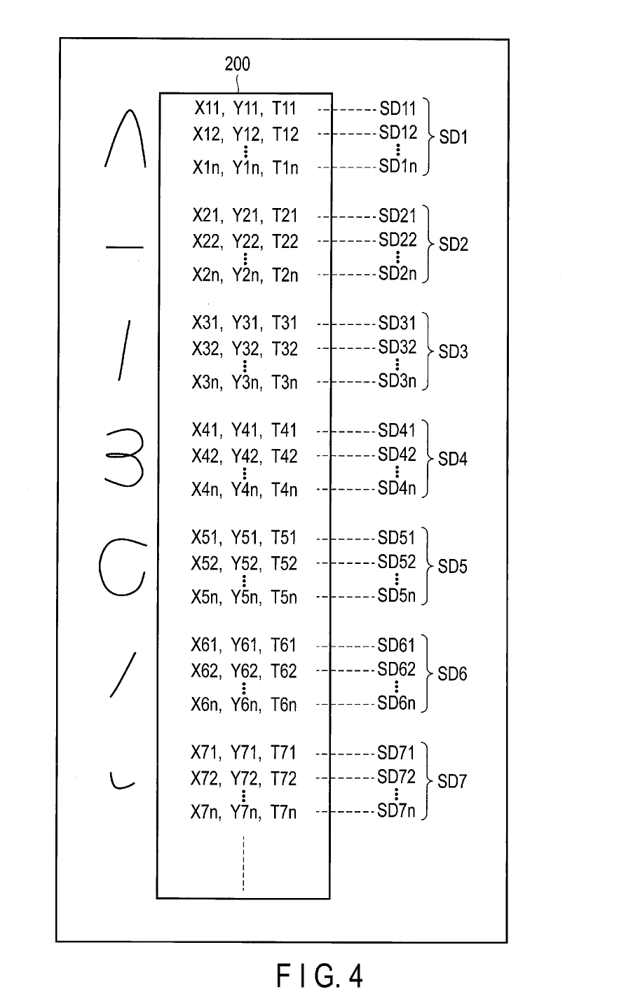

In the present embodiment, this handwritten document is stored in a storage medium as not image data, but time-series information (handwritten document data) representing both coordinate strings of a locus of each stroke and an order relationship between strokes. However, the handwritten document may be formed based on image data. The time-series information, which will be described later in detail with reference to FIG. 4, indicates the order in which plural strokes are handwritten, and includes plural stroke data elements corresponding to the plural strokes, respectively. In other words, the time-series information means a set of time-series stroke data elements corresponding to the plural strokes, respectively. Each stroke data element corresponds to one stroke, and includes coordinate data series (time-series coordinates) corresponding to respective points on a locus of the stroke. The order of arrangement of these stroke data elements corresponds to the order in which the respective strokes are handwritten.

The tablet computer 10 can read arbitrary, existing time-series information from the storage medium and display a handwritten document corresponding to the time-series information, i.e., plural strokes shown by the time-series information, on the screen. The plural strokes indicated by the time-series information are also plural strokes input by handwriting.

Furthermore, the tablet computer 10 of the present embodiment also has a touch input mode of executing the handwriting input operation with not the stylus 100, but a finger. If the touch input mode is valid, the user can execute the handwriting input operation with a finger, on the touchscreen display 17. In the touch input mode, a locus of a motion of the finger on the screen, i.e., a stroke handwritten by the handwriting input operation is obtained, and plural strokes input by handwriting are thereby displayed on the screen.

The tablet computer 10 has an edit function. The edit function can delete or move an arbitrary handwritten portion (handwritten character, handwritten mark, handwritten figure, handwritten table or the like) in a currently displayed handwritten document, which is selected by a range selection tool, based on an edit operation executed by the user using an eraser tool, the range selection tool, other various tools, or the like. In addition, the arbitrary handwritten portion in the handwritten document, which is selected by the range selection tool, can be designated as a search key for searching the handwritten document. Moreover, recognition processing such as handwritten character recognition/handwritten figure recognition/handwritten table recognition can be executed for the arbitrary handwritten portion in the handwritten document, which is selected by the range selection tool.

In the present embodiment, the handwritten document can be managed as one or plural pages. In this case, a set of elements of time-series information fitting in a screen may be recorded as one page, by separating the time-series information (handwritten document data) in units of an area that fits in a screen. Alternatively, the size of a page may be made variable. In this case, since the size of a page can be expanded to be larger in area than the size of one screen, a handwritten document larger in area than the size of the screen can be handled as one page. If the whole of one page cannot be displayed on the display at once, the page may be reduced in size or a portion to be displayed in the page may be moved by vertical and horizontal scrolling.

FIG. 2 shows the cooperation between the tablet computer 10 and an external device. The tablet computer 10 includes a wireless communication device such as a wireless LAN and can perform wireless communication with a personal computer 1. Furthermore, the tablet computer 10 can communicate with a server 2 on the Internet by the wireless communication device. The server 2 may be a server providing on-line storage services or other various cloud computing services.

The personal computer 1 includes a storage device such as a hard disk drive (HDD). The tablet computer 10 can transmit the time-series information (handwritten document data) to the personal computer 1 and record the time-series information in the HDD of the personal computer 1 (uploading). To assure secure communication between the tablet computer 10 and the personal computer 1, the personal computer 1 may authenticate the tablet computer 10 at the start of communication. In this case, a dialog which prompts the user to input an ID or a password may be displayed on the screen of the tablet computer 10 or the ID of the tablet computer 10 or the like may be transmitted automatically from the tablet computer 10 to the personal computer 1.

This enables the tablet computer 10 to handle a large number of elements of time-series information or a large amount of time-series information even if the capacity of the storage in the tablet computer 10 is small.

Furthermore, the tablet computer 10 can read at least one arbitrary element of the time-series information recorded in the HDD of the personal computer (downloading) and display a stroke indicated by the read time-series information on the screen of the display 17 of the tablet computer 10. In this case, a list of thumbnails obtained by reducing each page of the plural elements of time-series information may be displayed on the screen of the display 17 or one page selected from the thumbnails may be displayed in a normal size on the screen of the display 17.

Furthermore, a destination with which the tablet computer 10 communicates may not be the personal computer 1, but the server 2 on a cloud which provides storage services or the like. The tablet computer 10 can transmit the time-series information (handwritten document data) to the server 2 via the Internet and record the time-series information in a storage device 2A of the server 2 (uploading). Moreover, the tablet computer 10 can read (download) an arbitrary element of time-series information recorded in the storage device 2A of the server 2 and display a locus of each stroke shown by the time-series information on the display 17 of the tablet computer 10.

Thus, in the present embodiment, the storage medium in which the time-series information is stored may be any one of the storage device in the tablet computer 10, the storage device in the personal computer 1, and the storage device of the server 2.

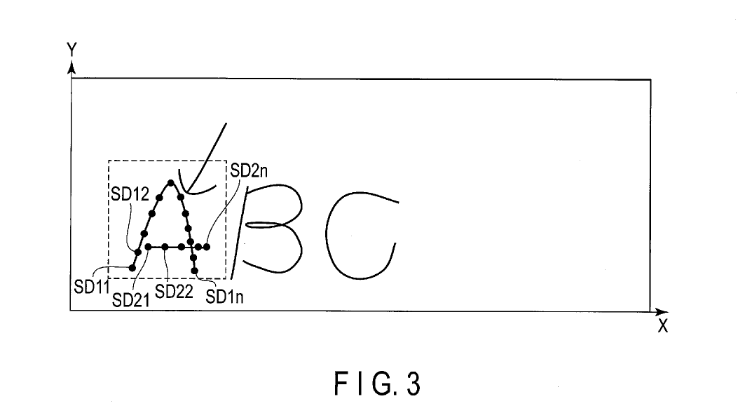

Next, a relationship between a stroke (character, figure, table, or the like) handwritten by the user and the time-series information will be explained with reference to FIG. 3 and FIG. 4. FIG. 3 shows an example of a handwritten document (or a handwritten character string) handwritten on the touchscreen display 17 with a stylus 100 or the like.

In the handwritten document, another character or figure is often handwritten over the character or the figure already input by handwriting. In FIG. 3, handwritten characters “A”, “B”, and “C” are input by handwriting in order and then a handwritten arrow is input by handwriting at a position very close to the handwritten character “A”.

The handwritten character “A” is represented by two strokes (a locus of a “̂” shape and a locus of a “-” shape) handwritten with the stylus 100 or the like, that is, by two loci. The first written locus of the stylus 100 in the “̂” shape is sampled in real time, for example, at regular time intervals, and time-series coordinates SD11, SD12, . . . , SD1n of the stroke in the “̂” shape can be thereby obtained. Similarly, the next handwritten locus of the stylus 100 in the “-” shape is also sampled in real time at the regular time intervals, and time-series coordinates SD21, SD22, . . . , SD2n of the stroke in the “-” shape can be thereby obtained.

The handwritten character “B” is represented by two strokes handwritten with the stylus 100 or the like, that is, by two loci. The handwritten character “C” is represented by one stroke handwritten with the stylus 100 or the like, that is, by one locus. The handwritten arrow is represented by two strokes handwritten with the stylus 100 or the like, that is, by two loci.

FIG. 4 shows time-series information 200 corresponding to the handwritten document shown in FIG. 3. The time-series information includes plural stroke data elements SD1, SD2, . . . , SD7. In the time-series information 200, these stroke data elements SD1, SD2, . . . , SD are arranged chronologically in the order in which the strokes have been handwritten.

In the time-series information 200, the first two stroke data elements SD1 and SD2 indicate the two strokes of the handwritten character “A”, respectively. A third stroke data element SD3 and a fourth stroke data element SD4 indicate the two strokes constituting the handwritten character “B”, respectively. A fifth stroke data element SD5 indicates one stroke constituting the handwritten character “C”. A sixth stroke data element SD6 and a seventh stroke data element SD7 indicate the two strokes constituting the handwritten arrow, respectively.

Each stroke data element includes a coordinate data series (time-series coordinates) corresponding to one stroke, that is, coordinates corresponding to respective sampling points on a locus of one stroke. In each stroke data element, the coordinates are arranged chronologically in the order in which the stroke has been written (sampled). For example, as regards the handwritten character “A”, the stroke data element SD1 includes a coordinate data series (time-series coordinates) corresponding to the respective points on the locus of the “̂”-shaped stroke of the handwritten character “A”, that is, the n coordinate data elements SD11, SD12, . . . , SD1n. The stroke data element SD2 includes a coordinate data series corresponding to the respective points on the locus of the “-”-shaped stroke of the handwritten character “A”, that is, the n coordinate data items SD21, SD22, . . . , SD2n. The number of coordinate data elements may differ for each stroke data element. If the stroke is sampled at regular time intervals, the number of sampling points differs since the length of the stroke differs.

Each element of the coordinate data indicates an x-coordinate and a y-coordinate of a certain point in the corresponding locus. For example, coordinate data SD11 indicates the x-coordinate (X11) and the y-coordinate (Y11) of the starting point of the “̂”-shaped stroke. SDn1 indicates the x-coordinate (X1n) and the y-coordinate (Y1n) of the end point of the “̂”-shaped stroke.

Each coordinate data element may include time stamp information T corresponding to a time (sampling timing) at which the point corresponding to the coordinates has been handwritten. The time at which the point has been handwritten may be either an absolute time (for example, year, month, day, hours, minutes, and seconds) or a relative time based on a certain time. For example, the absolute time (for example, year, month, day, hours, minutes, and seconds) at which writing a stroke started may be added as the time stamp information to each stroke data element and, furthermore, the relative time representing the difference from the absolute time may be added as the time stamp information T to each coordinate data element in the stroke data element.

Thus, the temporal relationship between strokes can be represented with more accuracy by using the time-series information in which the time stamp information T has been added to each coordinate data element. Although not shown in FIG. 4, information (Z) indicating a writing pressure may be added to each coordinate data element.

The time-series information 200 having the structure explained in FIG. 4 can represent not only each stroke, but also the temporal relationship between strokes. Therefore, use of the time-series information 200 enables the handwritten character “A” and the tip portion of the handwritten arrow to be handled as different characters or figures even if the tip portion of the handwritten arrow has been written so as to overlap the handwritten character “A” or to be close to the handwritten character “A” as shown in FIG. 3.

Moreover, in the present embodiment, as explained above, since the handwritten document data is stored as not images or character recognition results, but the time-series information 200 including sets of time-series stroke data elements, the handwritten characters can be handled independently of the language of the handwritten characters. Therefore, the structure of the time-series information 200 in the present embodiment can be used commonly in the same manner in various countries different in language around the world.

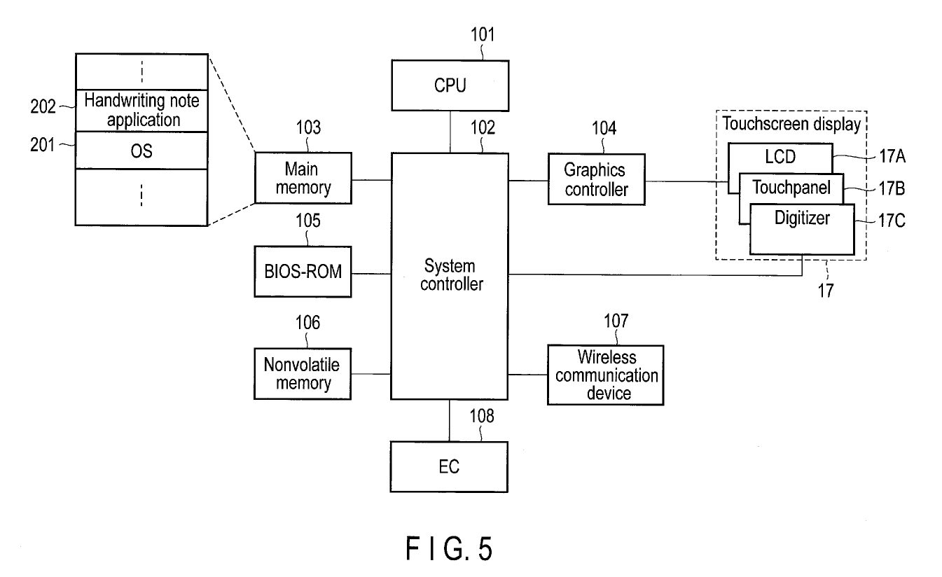

FIG. 5 shows a system configuration of the tablet computer 10.

The tablet computer 10 includes a CPU 101, a system controller 102, a main memory 103, a graphics controller 104, a BIOS-ROM 105, a nonvolatile memory 106, a wireless communication device 107, an embedded controller (EC) 108 and the like.

The CPU 101 is a hardware processor which controls the operations of various modules in the tablet computer 10. The CPU 101 executes various types of software loaded from the nonvolatile memory 106 serving as a storage device to the main memory 103. The software includes an operating system (OS) 201 and various application programs. The various application programs include a handwriting note application program 202. The handwritten document data is also called a handwritten note in the following explanations. The handwriting note application program 202 has a function of forming and displaying the above-explained handwritten document data, a function of editing the handwritten document data, and a handwritten document search function of searching for handwritten document data including a desired handwritten portion or a desired handwritten portion in certain handwritten document data.

The CPU 101 also executes a Basic Input/Output System (BIOS) stored in the BIOS-ROM 105. The BIOS is a program for hardware control.

The system controller 102 is a device which connects a local bus of the CPU 101 with various component modules. The system controller 102 also incorporates a memory controller which control access to the main memory 103. The system controller 102 also has a function of communicating with the graphics controller 104 via a serial bus conforming to the PCI EXPRESS standard.

The graphics controller 104 is a display controller which controls the LCD17A used as a display monitor of the tablet computer 10. A display signal produced by the graphics controller 104 is transmitted to the LCD 17A. The LCD 17A displays a screen image, based on the display signal. A touchpanel 17B, the LCD 17A and a digitizer 17C are superposed on each other. The touchpanel 17B is a capacitance pointing device for inputting on the screen of the LCD 17A. A touch position on the screen which the finger touches, the movement of the touch position and the like are detected by the touchpanel 12B. The digitizer 17C is an electromagnetic induction type pointing device for inputting on the screen of the LCD 17A. The touch position on the screen where the stylus (digitizer stylus) 100 touches, the movement of the touch position and the like are detected by the digitizer 17C.

The wireless communication device 107 is a device configured to execute wireless communication such as wireless LAN or 3G mobile communication. The EC 108 is a single-chip microcomputer which includes an embedded controller for power management. The EC 108 has a function of turning on or off the power supply of the tablet computer 10 in response to the user operation of a power button.

Next, several example of a representative screen presented to the user by the handwriting note application program 202 will be explained.

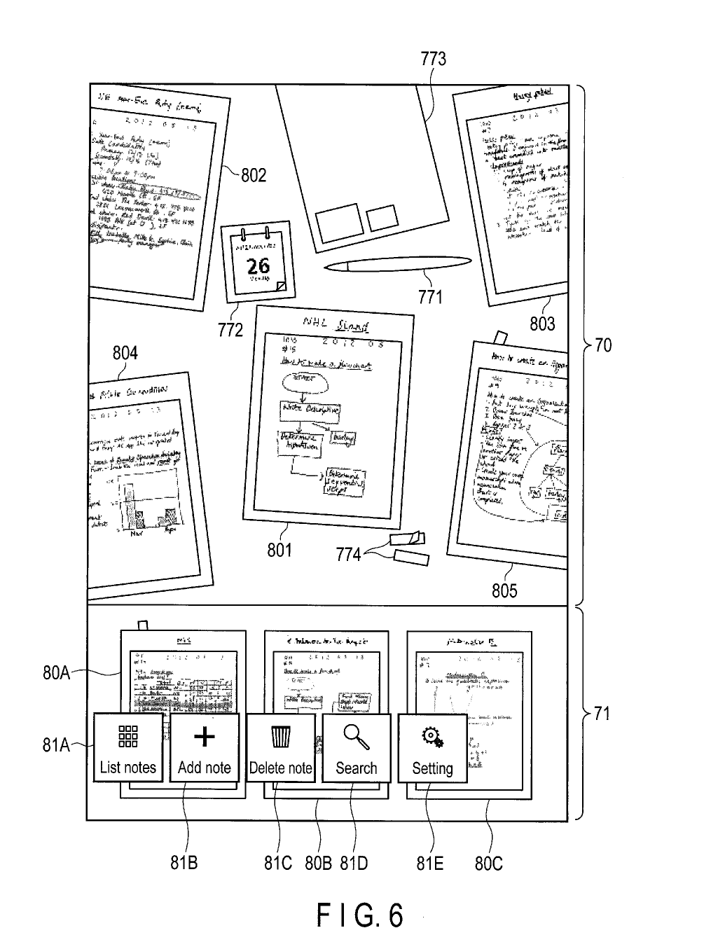

FIG. 6 shows an example of a home screen of the handwriting note application program 202. The home screen is a basic screen on which data of a plurality of handwritten document elements can be handled. On the home screen, a note can be managed and the whole application can be set.

The home screen includes a desktop screen region 70 and a drawer screen region 71. The desktop screen region 70 is a temporary region that displays a plurality of note icons 801 to 805 corresponding to a plurality of handwritten notes that are active. Each of the notebook icons 801 to 805 displays a thumbnail of a page of the corresponding handwritten note. The desktop screen region 70 also displays a stylus icon 771, a calendar icon 772, a scrap note (gallery) icon 773, and a tag (label) icon 774.

The stylus icon 771 is a graphical user interface (GUI) that switches an active display screen from a home screen to a page edit screen. The calendar icon 772 is an icon that displays a current date. The scrap note icon 773 is a GUI through which data derived from another application program or an external file (scrap data or gallery data) is browsed. The tag icon 774 is a GUI through which a label (tag) is placed on an arbitrary page of an arbitrary handwritten note.

The drawer screen region 71 is a display region in which a storage region for all created handwritten notes is browsed. The drawer screen region 71 displays note icons 80A, 80B, and 80C corresponding to several handwritten notes of all the handwritten notes. The note icons 80A, 80B, and 80C display thumbnails of arbitrary pages of corresponding handwritten notes. The handwriting note application program 202 can detect an arbitrary gesture (for example, a swipe gesture) performed by the user with the stylus 100 or his or her finger on the drawer screen region 71. If the gesture (for example, the swipe gesture) is detected, the handwriting note application program 202 scrolls a screen image on the drawer screen region 71 leftward or rightward. As a result, a note icon corresponding to an arbitrary handwritten note can be displayed on the drawer screen region 71.

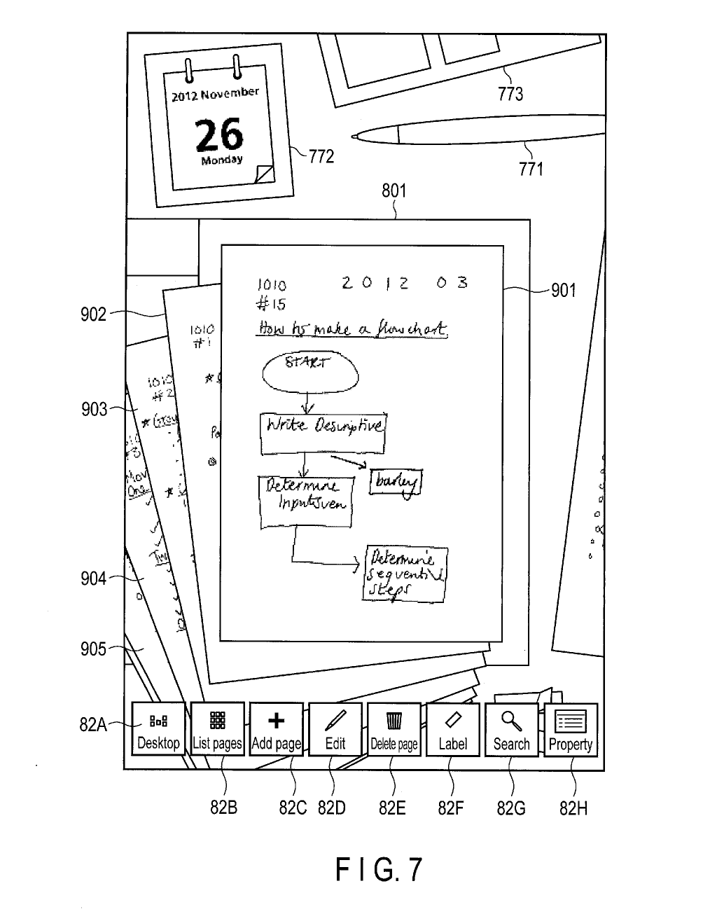

The handwriting note application program 202 can detect another gesture (for example, a tap gesture) performed by the user with the stylus 100 or his or her finger on a note icon of the drawer screen region 71. If the gesture (for example, the tap gesture) on the note icon of the drawer screen region 71 is detected, the handwriting note application program 202 moves the note icon to a center portion of the desktop screen region 70. Thereafter, the handwriting note application program 202 selects a handwritten note corresponding to the note icon and displays a note preview screen shown in FIG. 7 instead of the desktop screen. The note preview screen shown in FIG. 7 is a screen on which an arbitrary page of the selected handwritten note can be browsed.

In addition, the handwriting note application program 202 can detect a gesture (for example, a tap gesture) performed by the user with the stylus 100 or his or her finger on the desktop screen region 70. If the gesture (for example, the tap gesture) on the note icon at the center portion of the desktop screen region 70 is detected, the handwriting note application program 202 selects a handwritten note corresponding to a note icon at the center portion and displays the note preview screen shown in FIG. 7 instead of the desktop screen.

In addition, the home screen can display a menu. The menu includes a note list button 81A, a note creation button 81B, a note delete button 81C, a search button 81D, and a setting button 81E that are displayed at a lower portion of the screen, for example in the drawer screen region 71. The note list button 81A is a button that allows a list of handwritten notes to be displayed. The note creation button 81B is a button that allows a new handwritten note to be created (added). The note delete button 81C is a button that allows a handwritten note to be deleted. The search button 81D is a button that allows a search screen (search dialog) to be displayed. The setting button 81E is a button that allows an application setting screen to be opened.

Displayed below the drawer screen region 71 are a return button, a home button, and a recent application button (not shown).

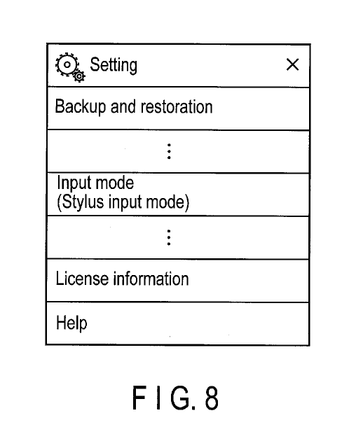

FIG. 8 shows an example of a setting screen that is opened when the setting button 81E is tapped with the stylus 100 or the user's finger.

The setting screen displays various setting items. The setting items includes “backup and restore”, “input mode (stylus or touch input mode)”, “license information” and “help”.

If the note creation button 81B is tapped on the home screen with the stylus 100 or the user's finger, a note creation screen is displayed. A name of a note is handwritten in a title field on the note creation screen. At this point, a cover paper and a paper type of the note can be selected. If the creation button is pressed, a new note is created. The created note is placed in the drawer screen region 71.

FIG. 7 shows an example of the note preview screen.

The note preview screen is a screen on which an arbitrary page of the selected handwritten note can be browsed. In this example, a case that a handwritten note corresponding to the note icon 801 in the desktop screen region 70 on the home screen has been selected will be explained. In this case, the handwriting note application program 202 displays a plurality of pages 901, 902, 903, 904, and 905, at least a part of each of pages 901, 902, 903, 904, and 905 contained in the handwritten note being visible and the pages 901, 902, 903, 904, and 905 being overlapped.

In addition, the note preview screen displays the stylus icon 711, the calendar icon 772, and the scrap note icon 773 that are explained above.

The note preview screen can also display a menu at the lower portion of the screen. The menu includes a home button 82A, a page list button 82B, a page add button 82C, a page edit button 82D, a page delete button 82E, a label button 82F, a search button 82G, and a property display button 82H. The home button 82A is a button that allows a preview of a note to be closed and the home screen to be opened. The page list button 82B is a button that allows a list of pages of a currently selected handwritten note to be displayed. The page add button 82C is a button that allows a new page to be created (added). The page edit button 82D is a button that allows a page edit screen to be displayed. The Page delete button 82E is a button that allows a page to be deleted. The label button 82F is a button that allows a list of types of available labels to be displayed. The search button 82G is a button that allows a search screen to be displayed. The property display button 82H is a button that allows a property of the note to be displayed.

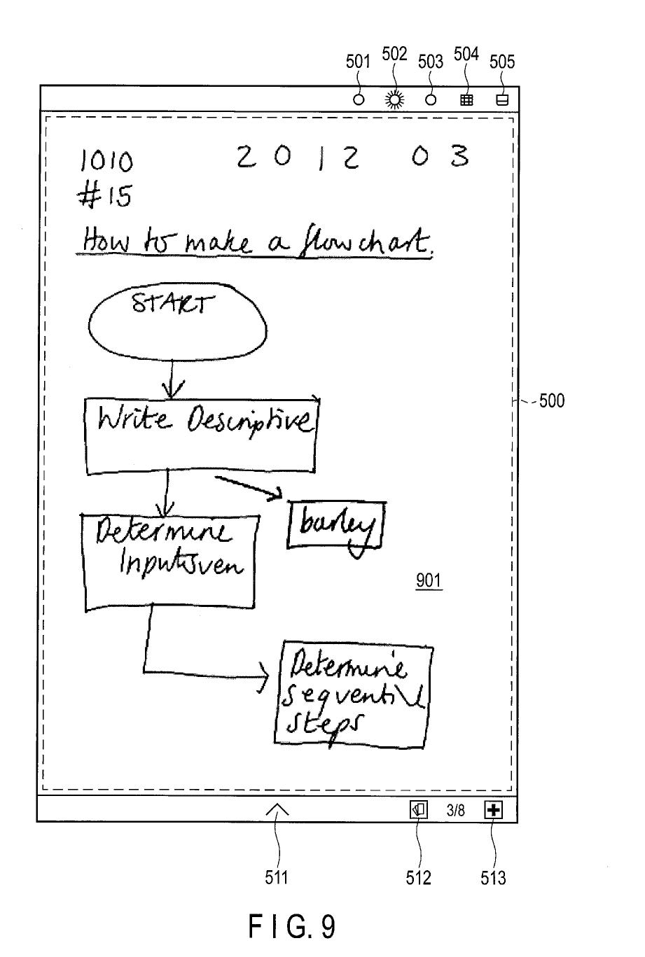

The handwriting note application program 202 can detect various types of gestures performed by the user on the note preview screen. If an arbitrary gesture is detected, the handwriting note application program 202 changes a page supposed to be displayed at a top of the screen to an arbitrary page (page forward, page backward). If an arbitrary gesture (for example, a tap gesture) on a top page or a gesture (for example, a tap gesture) on the stylus icon 771, or a gesture (for example, a tap gesture) on the page edit button 82D is detected, the handwriting note application program 202 selects the top page and displays the page edit screen shown in FIG. 9 instead of the note preview screen.

The page edit screen shown in FIG. 9 is a screen on which a new page (handwritten page) of a handwritten note can be created and an existing page of the handwritten note can be browsed and edited. If the page 901 is selected on the note preview screen shown in FIG. 7, contents of the page 901 are displayed on the page edit screen as shown in FIG. 9.

On the page edit screen, a rectangular region 500 surrounded by broken lines is a handwritten input region. In the handwritten input region 500, an event that is input from the digitizer 17C is used to display (draw) a handwritten stroke rather than an event that represents a gesture such as a tap. In the region other than the handwritten input region 500 on the page edit screen, an event that is input from the digitizer 17C can be used as an event that represents a gesture such as a tap.

An event that is input from the touchpanel 17B is used as an event that represents a gesture such as a tap or a swipe instead of an event that displays (draws) a handwritten stroke.

Displayed at the upper portion of the region other than the handwritten input region 500 on the page edit screen is a quick select menu including three types of styluses 501 to 503 that have been registered by the user, a range select stylus 504, and an erase stylus 505. In this example, a case that a black stylus 501, a red stylus 502, and a marker 503 have been registered by the user will be explained. If the user taps a stylus (button) on the quick select menu with the stylus 100 or his or her finger, a desired stylus type can be selected. For example, while the user has selected the black stylus 501 with the stylus 100 or a tap gesture of his or her finger, if he or she performs a handwriting input operation on the page edit screen with the stylus 100, the handwriting note application program 202 displays a black stroke (locus) on the page edit screen as the stylus 100 is moved.

One of the three types of styluses on the quick select menu may be selected with a side button (not shown) of the stylus 100. The three types of styluses can be set on the quick select menu as a combination of styluses with favorite thicknesses and colors.

Displayed at the lower portion other than the handwritten input region 500 on the page edit screen are also a menu button 511, a page backward (returning to the notebook preview screen) button 512, and a new page add button 513. The menu button 511 is a button that allows a menu to be displayed.

The menu may display other buttons such as a button that allows a current page to be placed in a trash box, a button that allows a part of a page that is copied or cut to be pasted, a button that allows the search screen to be opened, a button that allows an export submenu to be displayed, a button that allows an import submenu to be displayed, a button that allows a page to be converted into a text and the text to be mailed, and a button that allows a stylus case to be displayed. The export submenu allows the user to select a function for recognizing a handwritten page displayed on the page edit screen and converting it into an electronic text file, a presentation file, an image file, or the like or a function for converting a page into an image file and sharing it with another application. The import submenu allows the user to select for example a function for importing a memo from a memo gallery or a function for importing an image from a gallery. The stylus case is a button that allows a stylus setting screen on which colors (drawing line colors) and thicknesses (drawing line thicknesses) of the three types of styluses can be selected on the quick select menu to be evoked.

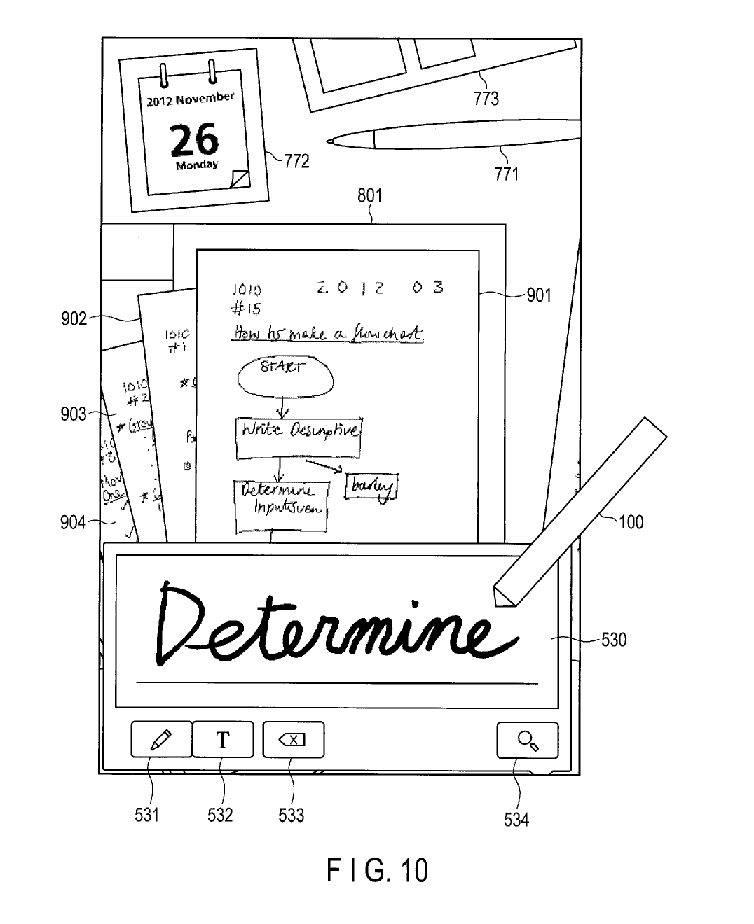

FIG. 10 shows an example of the search screen (search dialog). In FIG. 10, a case that the search button 82G has been selected on the note preview screen shown in FIG. 7 and the search screen (search dialog) has been opened on the note preview screen is explained.

The search screen displays a search key input region 530, a stroke search button 531, a text search button 532, a delete button 533, and a search execution button 534. The stroke search button 531 is a button that allows a stroke search to be selected. The text search button 532 is a button that allows a text search to be selected. The delete button 533 is a button that allows a search key in the search key input region 530 to be deleted. The search execution button 534 is a button that allows an execution of search processing to be requested.

If the stroke search is made, the search key input region 530 is used for a handwritten input region for a character string, a figure, or a table as a search key. In FIG. 10, handwritten character string “Determine” has been input as a search key in the search key input region 530. Besides a handwritten character string, the user can handwrite a figure, a table, or the like in the search key input region 530 with the stylus 100. While the user has input handwritten character string “Determine” as a search key in the search key input region 530, if he or she selects the search execution button 534, a handwritten document (note) including a stroke set corresponding to a stroke set (query stroke set) including handwritten character string “Determine” is searched. The document is searched for the stroke set similar to the query stroke set based on inter-stroke matching. If a similarity between the query stroke set that is similar to the stroke set is calculated, DP (Dynamic Programming) matching may be used.

If a text search is made, for example a software keyboard is displayed on the screen. The user can input an arbitrary text (character string) as a search key in the search key input region 530 through the software keyboard. While a text as a search key has been input to the search key input region 530, if the user selects the search execution button 534, the handwritten note including the stroke set that represents the text (query text) is searched.

All handwritten documents can be searched for a stroke or a text. Alternatively, a selected handwritten document can be searched for a stroke or a text. If a document is searched for a stroke or a text, a search result screen is displayed. On the search result screen, a list of handwritten documents (pages) including a stroke set corresponding to a query stroke set is disposed. A hit word (a stroke set corresponding to a query stroke set or a query text) is highlighted.

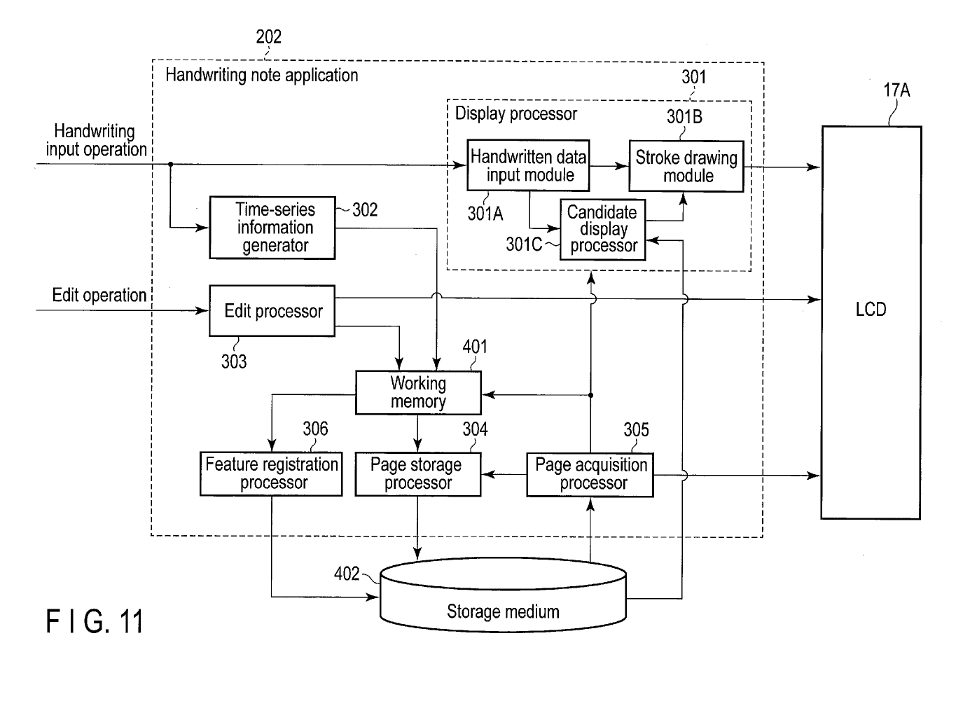

Next, with reference to FIG. 11, a functional configuration of the handwriting note application program 202 will be explained.

The handwriting note application program 202 is a WYSIWYG application that can handle handwritten document data. The handwriting note application program 202 includes for example a display processor 301, a time-series information generator 302, an edit processor 303, a page storage processor 304, a page acquisition processor 305, a feature registration processor 306, and a working memory 401. The display processor 301 includes a handwritten data input module 301A, a stroke drawing module 301B, and a candidate display processor 301C.

The touchpanel 17B detects events such as “touch”, “slide”, and “release”. “Touch” is an event that denotes that an object (finger) is touching the screen. “Slide” is an event that denotes that an object (finger) is moving while it is touching the screen. “Release” is an event that denotes that an object (finger) has been released from the screen.

The digitizer 17C also detects events such as “touch”, “slide”, and “release”. “Touch” is an even that denotes that an object (stylus 100) is touching the screen. “Slide” is an event that denotes that an object (stylus 100) is moving while it is touching the screen. “Release” is an event that denotes that an object (stylus 100) has been released from the screen.

The handwriting note application program 202 displays the page edit screen on the touchscreen display 17 such that handwritten page data can be created, browsed, or edited.

The display processor 301 and the time-series information generator 302 receive an event such as “touch”, “slide”, or “release” generated by the digitizer 17C and detect a handwriting input operation based on the received event. The “touch” event includes coordinates of a touch position. The “slide” event includes coordinates of a touch position of a moving destination. Thus, the display processor 301 and the time-series information generator 302 can receive a coordinate string corresponding to loci of the touch position received from the digitizer 17C.

The display processor 301 displays handwritten strokes on the screen as an object (stylus 100) detected by the digitizer 17C is moved. The display processor 301 displays loci of the stylus 100, namely loci of individual strokes, on the page edit screen while the stylus 100 is touching the screen.

The time-series information generator 302 receives the coordinate string from the digitizer 17C and generates handwritten data including time-series information (coordinate data series) including the structure explained with reference to FIG. 4. The time-series information generator 302 temporarily stores the created handwritten data to the working memory 401.

The edit processor 303 edits a handwritten page displayed on the screen. In other words, the edit processor 303 executes edit processing including processing for adding a new stroke (new handwritten character, new handwritten mark, or the like) to a handwritten page displayed on the screen and processing for deleting or moving at least one of a plurality of strokes displayed, according to an edit operation or a handwriting input operation performed by the user on the touchscreen display 17. In addition, the edit processor 303 updates time-series information stored in the working memory 401 in order to reflect a result of edit processing to time-series information that is displayed.

The page storage processor 304 stores handwritten page data including a plurality of stroke data elements corresponding to a plurality of handwritten strokes on a handwritten page that is being created to a storage medium 402. The storage medium 402 may be for example a storage device of the tablet computer 10 or a storage device of the server 2.

A page acquisition processor 307 acquires an arbitrary handwritten page data element from the storage medium 402. The acquired handwritten page data element is sent to the display processor 301. The display processor 301 displays a plurality of strokes corresponding to a plurality of stroke data elements of the handwritten page data on the screen.

If the page storage processor 304 stores the handwritten document to the storage medium 402, the feature registration processor 306 executes character recognition processing for a stroke set that composes a handwritten document (data) in order to convert all strokes that composes the handwritten document into a character string (word). The feature registration processor 306 correlates the converted character string as a keyword, a character recognition result of each stroke set that is strokes (recognized as characters by the character recognize processing) cumulated one by one in time series, and the number of strokes of the stroke set and registers them to a suggest feature table. In addition, the feature registration processor 306 correlates the converted character string (keyword) and stroke data corresponding to the stroke set converted into the character string and registers them to a suggest keyword table. The suggest feature table and the suggest keyword table have been stored for example in the storage medium 402.

Next, details of the display processor 301 shown in FIG. 11 will be explained.

As explained above, the touchpanel 17B or the digitizer 17C on the touchscreen display 17 detects a screen touch operation. The handwritten data input module 301A is a module that inputs a detection signal from the touchpanel 17B or the digitizer 17C. The detection signal includes coordinate information (X, Y) of a touch position. The detection signal is input in time series such that the handwritten data input module 301A inputs stroke data corresponding to handwritten strokes. The stroke data (detection signal) that are input by the handwritten data input module 301A is supplied to the stroke drawing module 301B.

The stroke drawing module 301B is a module that draws a locus (stroke) of handwritten input and displays it on the LCD 17A of the touchscreen display 17. The stroke drawing module 301B draws line segments of a locus (stroke) of handwritten input based on stroke data (detection signal) received from the handwritten data input module 301A.

If stroke data that is input by the handwritten data input module 301A corresponds to a handwritten stroke on the page edit screen (handwritten input region 500), the stroke data is also supplied to the candidate display processor 301C. If the stroke data is input by the handwritten data input module 301A, the candidate display processor 301C displays a candidate (handwriting candidate) of a character string that the user intends to handwrite (namely, a character string that he or she intends to input) in a candidate display region (first region) on the page edit screen based on stroke data that has been input when the stroke data supplied from the handwritten data input module 301A has been input. Specifically, the candidate display processor 301C displays at least one stroke set (handwriting) defined by at least one stroke (first stroke) as a candidate of a handwritten character string. A stroke set displayed in the candidate display region on the page edit screen as a candidate of a character string is identified with reference to the suggest feature table and the suggest keyword table stored in the storage medium 402 as will be explained later.

In the following explanation, a stroke set displayed in the candidate display region on the page edit screen is conveniently referred to as a candidate of a character string.

If a candidate of a character string is displayed in the candidate display region on the page edit screen, the user can select (designate) the candidate of the character string as a character string displayed (written) in the handwritten input region 500. If the user selects a candidate of a character string displayed in the candidate display region (namely, the user designates a candidate of a character string), the stroke drawing module 301B displays the character string (its candidate) in the handwritten input region 500 on the page edit screen. At this point, the stroke drawing module 301B displays a stroke set (a candidate of a character string) in the handwritten input region 500 based on coordinates (first coordinates) of the stroke set identified as a candidate of the character string by the candidate display processor 301C (namely, a stroke set displayed in the candidate display region as a candidate of the character string). The coordinates of the stroke set are relatively defined based on stroke data (time-series coordinates contained in the stroke data) that has been input. In the following explanations, coordinates of a candidate of a character string (a stroke set displayed in the candidate display region as a candidate of a character string) are conveniently referred to as relative coordinates.

When a candidate of a character string is displayed in the handwritten input region 500 as explained above, if the handwritten input region 500 does not have a space (blank) depending on a position of a handwritten stroke on the screen (namely, time-series coordinates contained in stroke data input by the handwritten data input module 301A), the character string (a candidate thereof) may not be displayed in the handwritten input region 500 based on the relative coordinates. In this case, the stroke drawing module 301B displays the character string in the handwritten input region 500 based on coordinates converted from the relative coordinates (hereinafter referred to as converted coordinates). The converted coordinates are coordinates where at least a part of the relative coordinates is converted based on the display region on the screen (handwritten input region 500).

Although not shown in FIG. 11, the handwriting note application program 202 also includes a search processor that executes the stroke search, text search, and so forth.

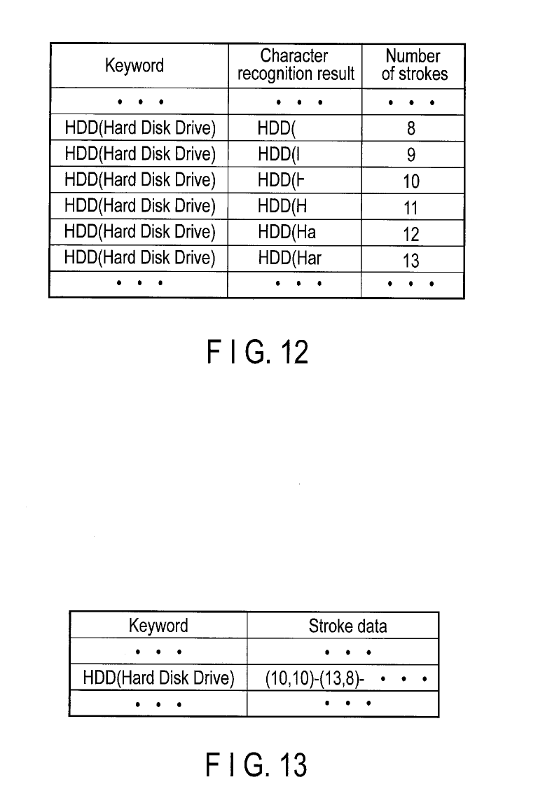

FIG. 12 shows an example of a data structure of the suggest feature table stored in the storage medium 402. As shown in FIG. 12, the suggest feature table correlatively stores a keyword, a character recognition result, and the number of strokes. The keyword is a character string (text) corresponding to a candidate of a character string. The character recognition result is a character recognition result for a part of a stroke set (handwritten character string) recognized as a keyword. The number of strokes represents the number of strokes of a stroke set of the character recognition result.

In the example shown in FIG. 12, the suggest feature table correlatively stores for example keyword “HDD (Hard Disk Drive)”, character recognition result “HDD (”, and number of stroke “8”. As a result, if the user handwrites eight strokes of a stroke set recognized as keyword “HDD (Hard Disk Drive)”, the character recognition result is “HDD (”.

In addition, the suggest feature table correlatively stores for example keyword “HDD (Hard Disk Drive)”, character recognition result “HDD (|”, and number of stroke “9”. As a result, if the user handwrites nine strokes of a stroke set recognized as keyword “HDD (Hard Disk Drive)”, the character recognition result is “HDD (|”.

Thus, the suggest feature table stores character recognition results corresponding to the numbers of strokes that compose keyword “HDD (Hard Disk Drive)” and that are incremented by 1. In other words, the suggest feature table correlatively stores character recognition results of each stroke set that is strokes cumulated one by one in time-series order among strokes as recognized as the keyword, number of strokes of the stroke sets, and the keyword.

As will be explained later, if a candidate of a character string is displayed, a search is made for a character recognition result and the number of strokes as search keys.

FIG. 13 shows an example of a data structure of the suggest keyword table stored in the storage medium 402. As shown in FIG. 13, the suggest keyword table correlatively stores (registers) a keyword as a main key and stroke data. The keyword is a character string (text) corresponding to a candidate of a character string. The stroke data is data (binary data of a stroke) corresponding to a stroke set recognized as a keyword.

In the example shown in FIG. 13, the suggest keyword table correlatively stores for example keyword “HDD (Hard Disk Drive)” and stroke data “(10, 10)-(13, 8)- . . . ”. Thus, stroke data corresponding to a stroke set recognized as keyword “HDD (Hard Disk Drive)” is “(10, 10)-(13, 8)- . . . ”. As explained above, stroke data includes a plurality of coordinates corresponding to a plurality of sampling points on loci of strokes.

The foregoing technique can be applied for other keywords besides keyword “HDD (Hard Disk Drive)”.

Next, an operation of the tablet computer 10 in accordance with the present embodiment will be explained. Among processing executed by the tablet computer 10 in accordance with the present embodiment, feature registration processing, candidate display processing, and selected character string display processing will be explained.

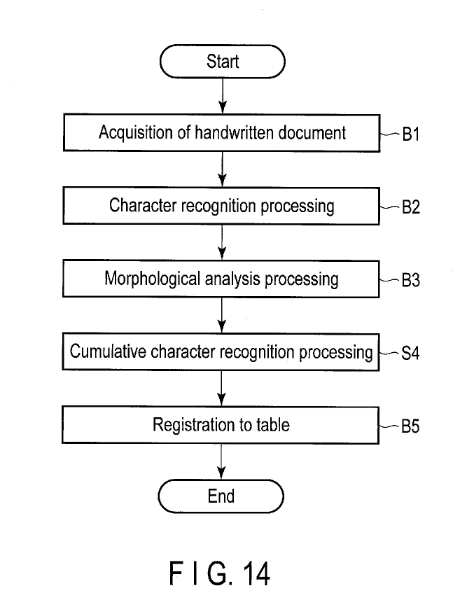

First, with reference to a flowchart shown in FIG. 14, a procedure of the feature registration processing will be explained. If a handwritten document (data) is stored in the storage medium 402, the feature registration processing is executed by the feature registration processor 306.

In the feature registration processing, if a handwritten document is stored in the storage medium 402 by the page acquisition processor 305, the feature registration processor 306 acquires the handwritten document from the working memory 401 (in block B1). A handwritten document includes stroke data corresponding to a stroke set handwritten by the user in the handwritten input region 500 on the page edit screen.

Thereafter, the feature registration processor 306 executes the character recognition processing for the acquired handwritten document (stroke sets corresponding to stroke data contained in the acquired handwritten document) (in block B2). As a result, the stroke sets that compose the handwritten document are converted into a character string. At this point, each stroke that composes the handwritten document (stroke data corresponding to each stroke) has been correlated with a character (composed by the stroke) of the character string converted by the character recognition processing to which the stroke belongs.

The feature registration processor 306 executes morphological analysis processing for the converted character string (in block B3). As a result, the converted character string is divided into words. At this point, the feature registration processor 306 identifies a stroke set that belongs to each word divided by the morphological analysis processing based on a stroke corresponding to each character of the character string.

Thereafter, the feature registration processor 306 executes cumulative character recognition processing for a stroke set that belongs to each word divided by the morphological analysis processing (in block B4). The cumulative character recognition processing is processing for acquiring a character recognition result (character string) as a feature amount for each stroke.

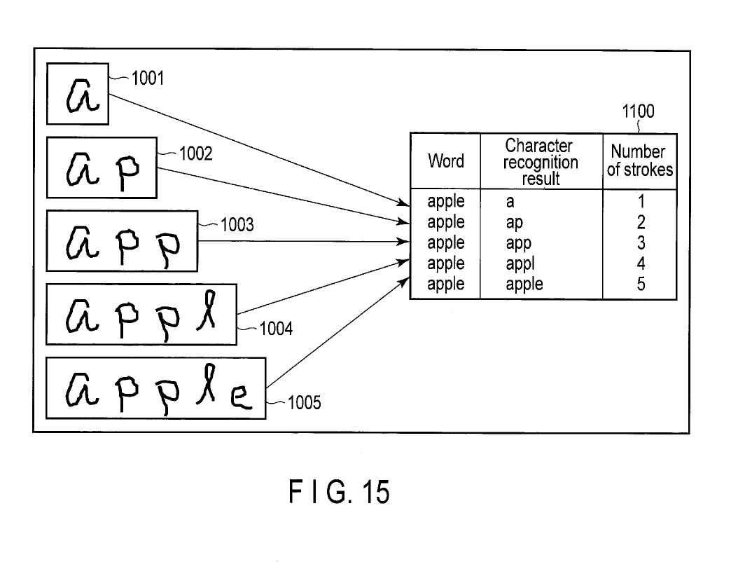

Next, with reference to FIG. 15, the cumulative character recognition processing will be specifically explained. In this example, for convenience, a case that the cumulative character recognition processing is executed for a stroke set that belongs to word “apple” will be explained. In the example shown in FIG. 15, it is assumed that characters “a” and “p” are written in one stroke each.

In this case, if the character recognition processing is executed for a stroke (set) 1001 whose number of strokes is 1, the character recognition is “a”.

If the character recognition processing is executed for a stroke set 1002 whose number of strokes is 2, the character recognition is “ap”.

If the character recognition processing is executed for a stroke set 1003 whose number of strokes is 3, the character recognition is “app”.

If the character recognition processing is executed for a stroke set 1004 whose number of strokes is 4, the character recognition is “appl”.

Lastly, if the character recognition processing is executed for a stroke set 1005 whose number of strokes is 5, the character recognition is “apple”.

As explained above, if the cumulative character recognition processing is executed for a stroke set that belongs to word “apple”, a cumulative character recognition result 1100 shown in FIG. 15 can be acquired. The cumulative character recognition result 1100 includes a word, character recognition result corresponding to stroke set, and numbers of strokes (numbers of strokes of the stroke set).

In the above example, the cumulative character recognition processing is executed for a stroke set that belongs to a word in block B4. Alternatively, the cumulative character recognition processing may be executed for a character string that includes a plurality of words that can be handled as one set. A character string including a plurality of words that can be handled as one set may include a character string or the like including initial characters followed by words in parentheses, for example “HDD (Hard Disk Drive)”. Alternatively, the cumulative character recognition processing may be executed for a compound word including a plurality of words (morphemes).

Returning to FIG. 14, the feature registration processor 306 registers each type of information to the suggest feature table and the suggest keyword table based on the acquired cumulative character recognition result 1100 (in block B5).

Specifically, the feature registration processor 306 correlatively registers words (keywords), the character recognition results, and the numbers of strokes contained in the cumulative character recognition result 1100 to the suggest feature table. In addition, the feature registration processor 306 registers a word (keyword) contained in the cumulative character recognition result and stroke data corresponding to the stroke set that belongs to the word (keyword) to the suggest keyword table.

If the information to be registered to the suggest feature table and the suggest keyword table is the same information as information to have already stored in the suggest feature table and the suggest keyword table, the registration processing for the information is omitted in block B5.

In the feature registration processing, if a handwritten document is stored to the storage medium 402, information necessary for candidate display processing that will be explained later can be automatically registered to the suggest feature table and the suggest keyword table.

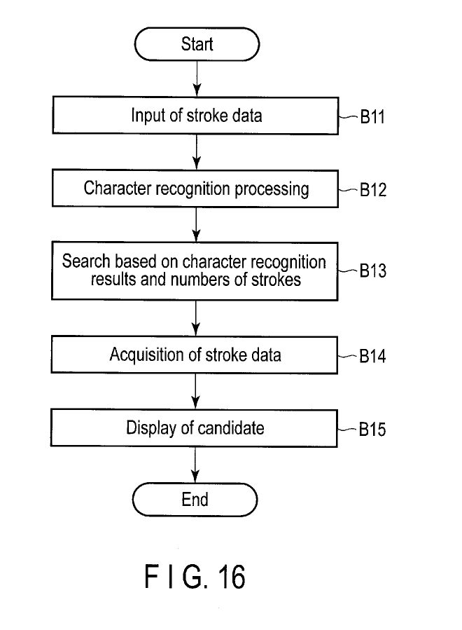

Next, with reference to a flowchart shown in FIG. 16, a procedure of the candidate display processing will be explained. The candidate display processing is executed by the candidate display processor 301C if stroke data corresponding to a stroke handwritten in the handwritten input region 500 on the page edit screen is input.

In the candidate display processing, the candidate display processor 301C inputs stroke data corresponding to one stroke handwritten by the user in the handwritten input region 500 on the page edit screen (in block B11). Hereinafter, stroke data that is input in block B11 is referred to as target stroke data.

Thereafter, the candidate display processor 301C executes the character recognition processing (cumulative character recognition processing) for a stroke set corresponding to stroke data that has been input if the target stroke data has been input (namely a stroke set handwritten in the handwritten input region 500) (at block B12). Specifically, if the target stroke data is stroke data corresponding to an n-th stroke of a handwritten character string, the candidate display processor 301C executes the character recognition processing for first to n strokes of a stroke set. As a result, the candidate display processor 301C acquires character recognition results. It is assumed that the first stroke is identified based on positions or the like of other strokes handwritten in the handwritten input region 500.

The candidate display processor 301C makes a search for a keyword (namely, a candidate of a character string that the user intends to handwrite) corresponding to a stroke set (namely, first to n strokes of a stroke set) based on the acquired character recognition results and the number of strokes of the stroke set from which the character recognition results are acquired (in block B13). Specifically, the candidate display processor 301C makes a search for a keyword stored in the suggest feature table in association with the acquired character recognition results and the number of strokes of the stroke set from which the character recognition results are acquired. In block B13, a search for a plurality of keywords may be made.

Thereafter, the candidate display processor 301C acquires stroke data corresponding to the stroke set that composes the keyword for which the search has been made (in block B14). Specifically, the candidate display processor 301C acquires stroke data correlated with the keyword for which the search has been made from the suggest keyword table.

The candidate display processor 301C draws the acquired stroke data (a stroke set corresponding to the acquired stroke data) in the candidate display region on the page edit screen and displays a candidate of a character string.

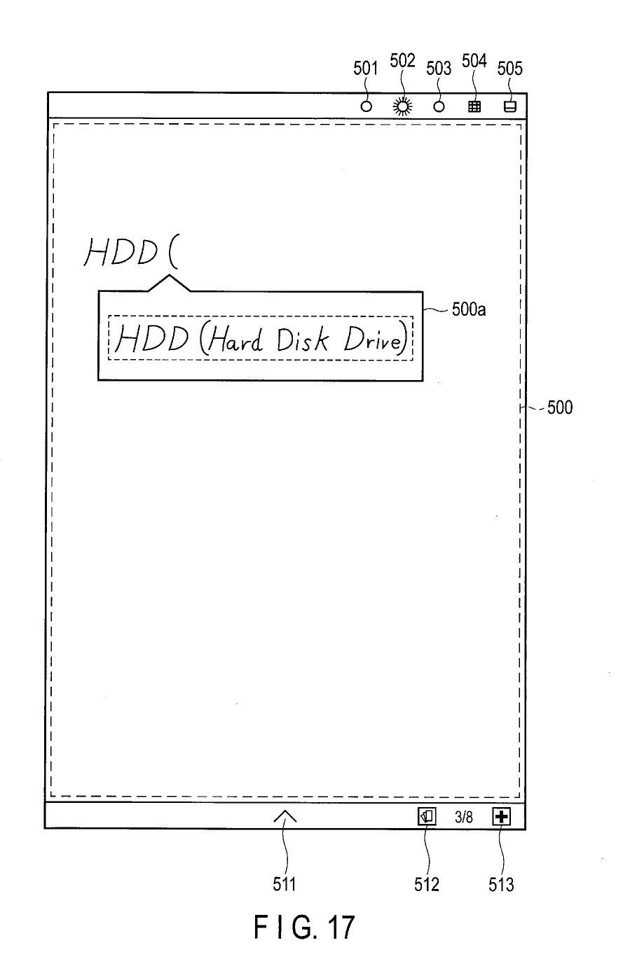

Next, with reference to FIG. 17, the candidate display region in which a candidate of a character string is displayed by the candidate display processing will be specifically explained. Similar portions to those in FIG. 9 will be designated by similar reference numerals and their explanation will be omitted.

As shown in FIG. 17, it is assumed that the user has handwritten character string “HDD (” in the handwritten input region 500 on the page edit screen. In this case, a candidate display region 500a is displayed on the page edit screen. In addition, a stroke set (namely, a stroke set that composes handwritten character string “HDD (Hard Disk Drive)” corresponding to a stroke set (namely, a stroke set that composes handwritten character string “HDD(”) corresponding to stroke data that has been input when the user has handwritten stroke “(” is displayed as a candidate of a character string in the candidate display region 500a.

The stroke set (handwritten character string “HDD (Hard Disk Drive)”) displayed in the candidate display region 500a as a candidate of a character string is a stroke set corresponding to the stroke data acquired at block B14 shown in FIG. 16.

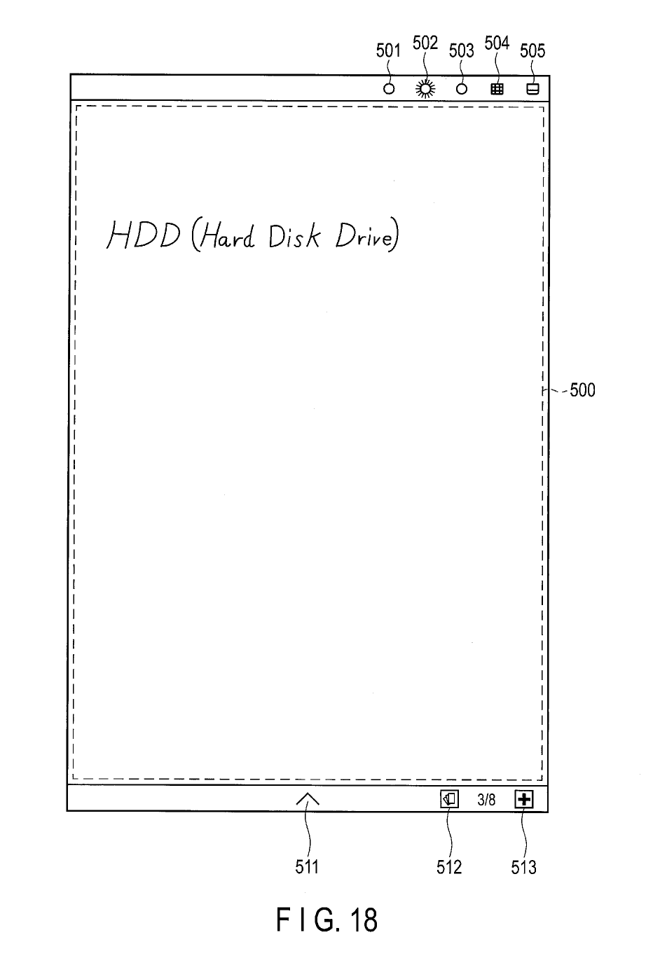

The user can select (designate) the candidate of the character string displayed in the candidate display region 500a on the page edit screen shown in FIG. 17. In this case, as shown in FIG. 18, the character string (the candidate of the character string) selected by the user is displayed in the handwritten input region 500.

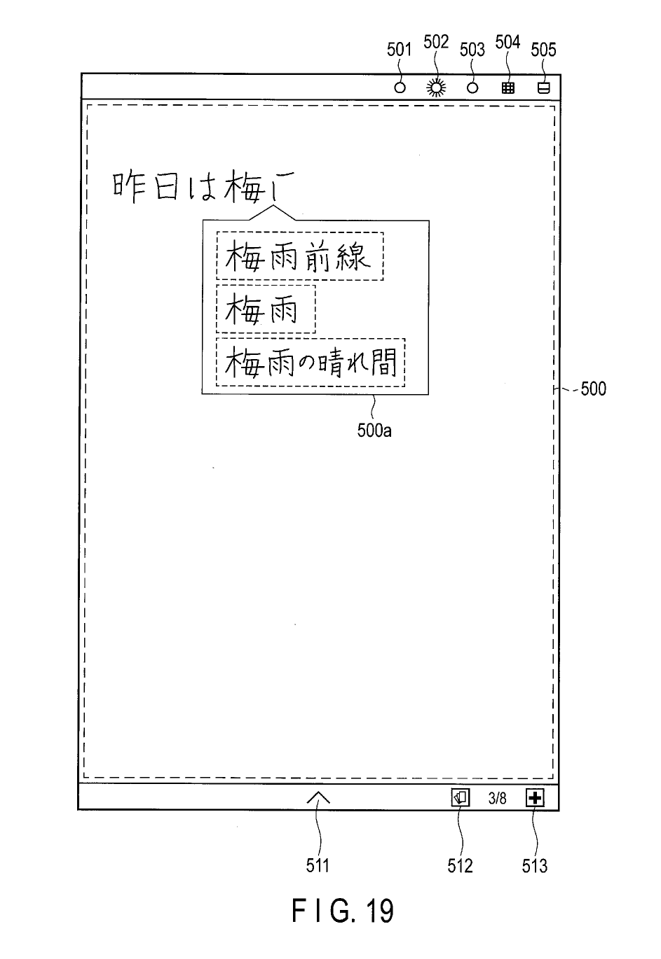

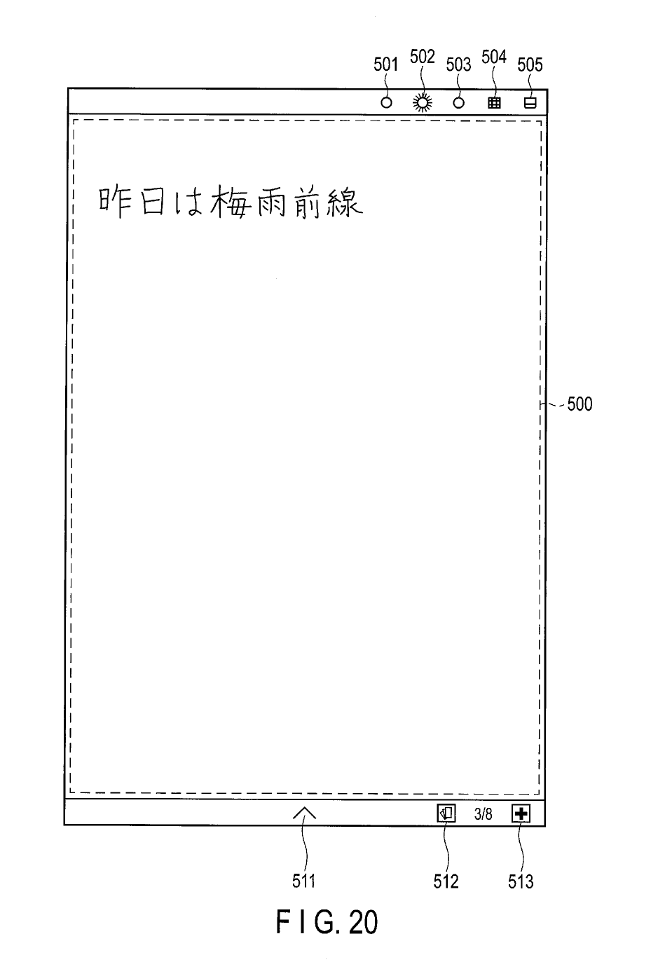

In FIG. 17 and FIG. 18, a language of the character string handwritten by the user in the handwritten input region 500 is English. FIG. 19 and FIG. 20 show a case that the language is Japanese.

In FIG. 17, only one candidate (stroke set) of a character string is displayed in the candidate display region 500a. If a search is made for a plurality of keywords in block B13, a plurality of candidates of a character string is displayed in the candidate display region 500a as shown in FIG. 19. In this case, the plurality of candidates of the character string may be displayed in the candidate display region 500a in an order of priorities based on frequencies at which the candidates (stroke sets) of the character string appear in handwritten documents stored in the storage medium 402. In addition to the order of priorities based on appearance frequencies, the order of priorities based on the number of times the user has selected character strings displayed (handwritten) in the handwritten input region 500 (hereinafter, referred to as the selection times) if candidates of character strings have been displayed in the candidate display region 500a may be considered. Alternatively, instead of the order of priorities based on appearance frequencies, only the order of priorities based on the selection times may be used.

Information of the appearance frequencies and selection times for each candidate (keyword) of each character string may be stored in the suggest keyword table or the like provided they are necessary.

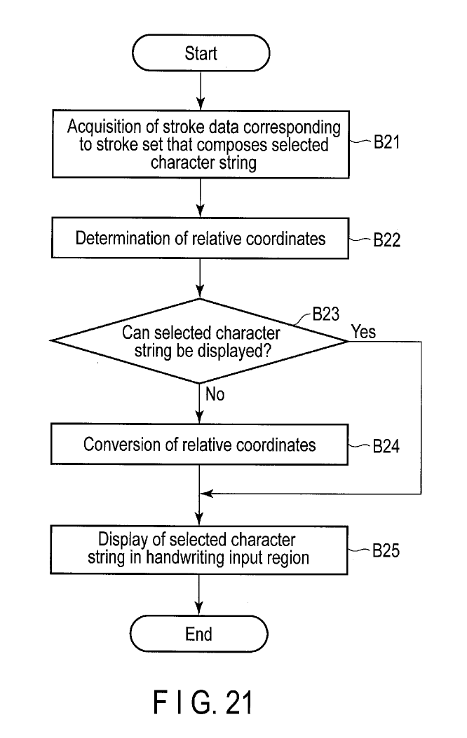

Next, with reference to a flowchart shown in FIG. 21, a procedure of selected character display processing will be explained. The selected character string display processing is executed by the stroke drawing module 301B when the user selects a candidate of a character string displayed by the candidate display processing (namely, the user designates the candidate of the character string). In the following explanation, a candidate of a character string displayed by the candidate display processing and selected by the user is referred to as a selected character string.

In the selected character string display processing, the stroke drawing module 301B acquires stroke data corresponding to a stroke set that composes a selected character string (handwritten character string) (in block B21). The acquired stroke data includes time-series coordinates (a plurality of coordinates) corresponding to a plurality of sampling points on loci of individual strokes. The stroke data is acquired for example from the suggest keyword table.

Thereafter, the stroke drawing module 301B determines coordinates (relative coordinates) of a selected character string relatively defined based on stroke data (namely, a stroke set written in the handwritten input region 500) that has been input when the selected character string has been displayed as a candidate of the character string in the candidate display region 500a (in block B22).

Specifically, a bounding rectangle (coordinates) of a stroke set (handwritten character string) corresponding to stroke data that has been input is calculated. If the user handwrites a character string (stroke set) in a horizontal direction, relative coordinates of the selected character string are determined based on a left end of the calculated bounding rectangle (for example, an upper left vertex of the bounding rectangle). Alternatively, the relative coordinates of the selected character string may be determined based on a start point of a first stroke of the stroke set corresponding to the stroke data that has been input.

With the relative coordinates determined in such a manner, a selected character string can be displayed at an appropriate position corresponding to a stroke set handwritten in the handwritten input region 500 by the user.

Thereafter, the stroke drawing module 301B determines whether or not the selected character string (a stroke set that composes the selected character string) can be displayed in the handwritten input region 500 (in block B23). In this case, the stroke drawing module 301B determines whether or not there is a space in which the selected character string can be displayed in the handwritten input region 500 based on the relative coordinates. The space in which the selected character string can be displayed is a region that is included in the handwritten input region 500 and that is free from other strokes.

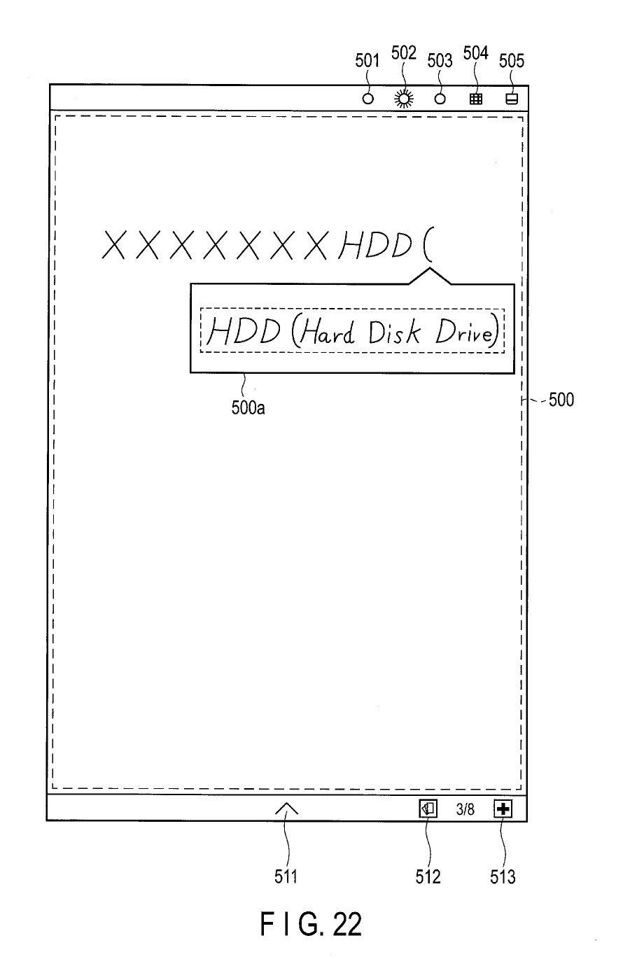

Next, with reference to FIG. 22, an example of a case in which a selected character string cannot be displayed in the handwritten input region 500 based on the relative coordinates will be explained.

As shown in FIG. 22, it is assumed that the user has handwritten character string “HDD (” rightward from a center of the handwritten input region 500 on the page edit screen. In this case, the candidate display region 500a is displayed on the page edit screen. Handwritten character string “HDD (Hard Disk Drive)” (a stroke set that composes the handwritten character string) is displayed as a candidate of a character string in the candidate display region 500a.

In this case, if the user selects the candidate of the character string (handwritten character string “HDD (Hard Disk Drive”) displayed in the candidate display region 500a, the selected character string (handwritten character string “HDD (Hard Disk Drive)”) instead of handwritten character string “HDD (” is displayed (input) in the candidate display region 500a.

Since the user has handwritten a character string in the horizontal direction in the example shown in FIG. 22, the selected character string is displayed on a right side of handwritten character string “HDD (” displayed in the handwritten input region 500. However, there is no space in which the selected character string (handwritten character string “HDD (Hard Disk Drive)”) is displayed on the right side of handwritten character string “HDD (” handwritten in the handwritten input region 500 by the user. In other words, if the selected character string is displayed based on the relative coordinates, a part of the selected character string is not fit to the handwritten input region 500.

Thus, when shown in FIG. 22, in block B23, it is determined that the selected character string cannot be displayed in the handwritten input region 500 based on the relative coordinates.

In other words, when the selected character string is displayed in the handwritten input region 500 based on the relative coordinates, if the selected character string cannot be displayed on one line (namely, a line that includes handwritten character string “HDD (” handwritten in the handwritten input region 500), it is determined that the selected character string cannot be displayed in the handwritten input region 500 based on the relative coordinates in block B23.

On the other hand, when shown in FIG. 17 (and FIG. 18), since there is a space in which the selected character string is displayed, it is determined that the selected character string can be displayed in the handwritten input region 500 based on the relative coordinates in block B23.

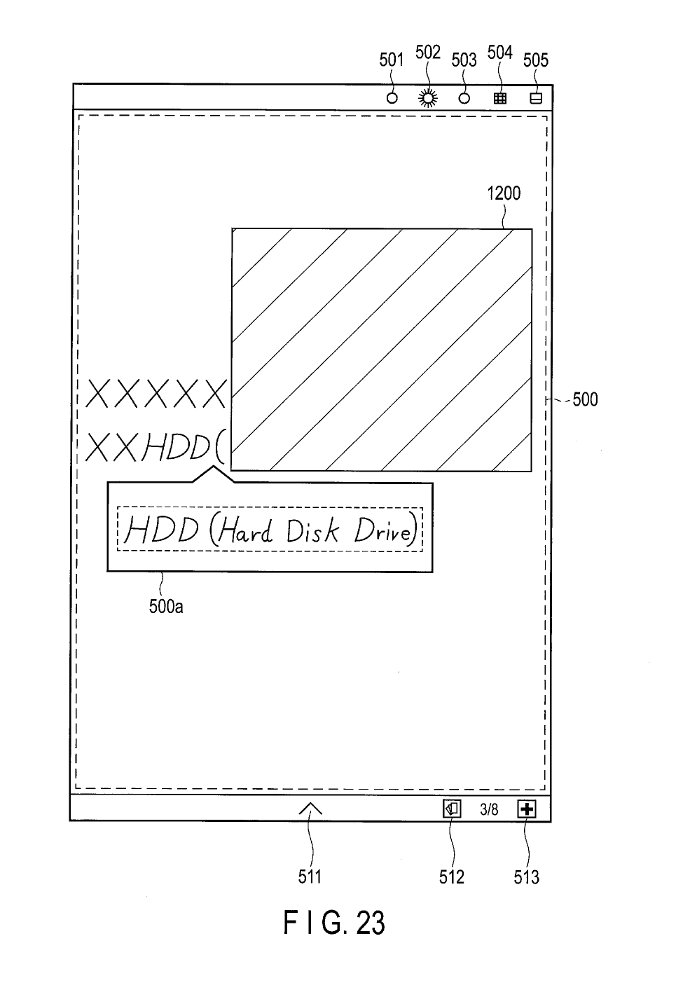

As explained above, a space in which the selected character string can be displayed is a region where another stroke is not displayed. Thus, as shown in FIG. 23, if another stroke, for example a FIG. 1200 or the like, has been displayed (handwritten) on a right side of handwritten character string “HDD (” in the handwritten input region 500 by the user, it is determined that the selected character string cannot be displayed in the handwritten input region 500 based on the relative coordinates in block B23.

Returning to FIG. 21 again, if it has been determined that the selected character string cannot be displayed in the handwritten input region 500 based on the relative coordinates in block B23, the stroke drawing module 301B converts the relative coordinates of the selected character string (at least a part of the relative coordinates) (in block B24). At this point, the stroke drawing module 301B converts the relative coordinates of the selected character string such that the selected character string is fit to the handwritten input region 500. Specifically, the relative coordinates of the selected character string (at least a part of the relative coordinates) are converted based on strokes included in a region corresponding to the relative coordinates and a positional relationship between the handwritten input region 500 and a region corresponding to the relative coordinates on the screen.

The stroke drawing module 301B displays the selected character string in the handwritten input region 500 based on the converted coordinates (in block B25).

In contrast, if it has been determined that the selected character string can be displayed in the handwritten input region 500 based on the relative coordinates in block B23, the processing advances to block B25 instead of block B24. In other words, if the selected character string can be displayed based on the relative coordinates, the selected character string is displayed in the handwritten input region 500 based on the relative coordinates without need to convert the relative coordinates.

Next, first to third display examples of the selected character string displayed by the processing in blocks B24 and B25 shown in FIG. 21 will be specifically explained. In this example, it is assumed that while handwritten character string “XXXXXXX” and handwritten character string “HDD (” have been handwritten on one line in the handwritten input region 500 as shown in FIG. 22 and handwritten character string “HDD (Hard Disk Drive)” is displayed as a candidate of a character string in the candidate display region 500a, the candidate of the character string has been selected by the user.

In the first display example, the selected character string (a stroke set that composes the selected character string) is displayed in a reduced size such that the selected character string is fit to the handwritten input region 500. In this case, coordinates contained in stroke data corresponding to a stroke set that composes handwritten character string “XXXXXXX” in the handwritten input region 500 and relative coordinates of the selected character string are converted such that character widths and character pitches of the handwritten character string and the selected character string are reduced.

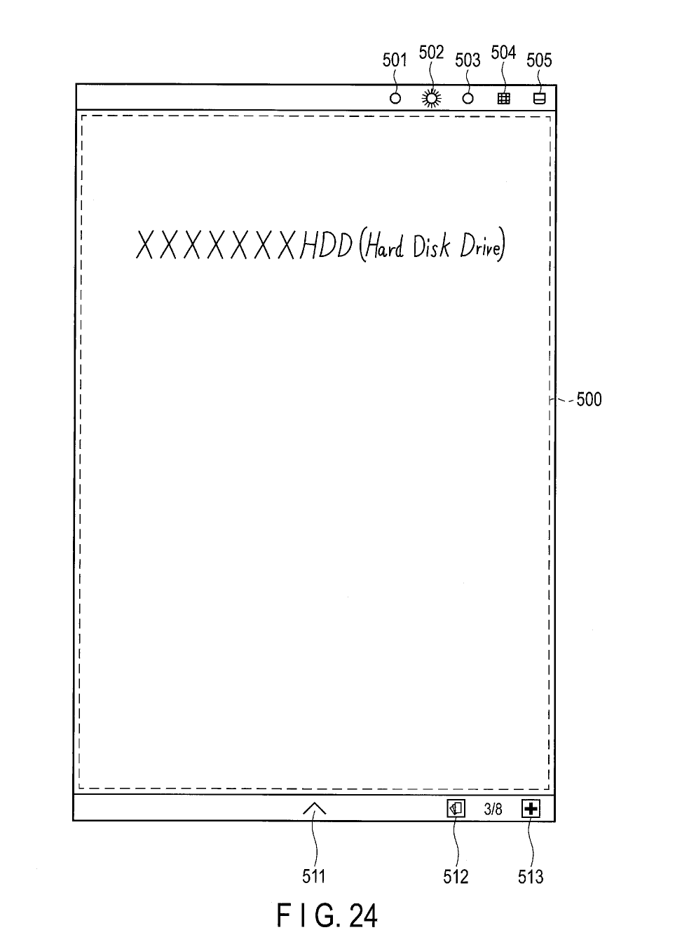

Thus, in the first display example, as shown in FIG. 24, a stroke set that composes handwritten character string “XXXXXXX” and the selected character string (handwritten character string “HDD (Hard Disk Drive)”) is displayed in a reduced size in a line direction.

A reduction rate is set based on a width of a space in which handwritten character string “XXXXXXX” and a selected character string are displayed (a width of a space in which other strokes have not been written) such that handwritten character string “XXXXXXX” and the selected character string can be displayed on one line. A character string contained in one line is recognized based on coordinates contained in stroke data corresponding to individual strokes that compose the character string.

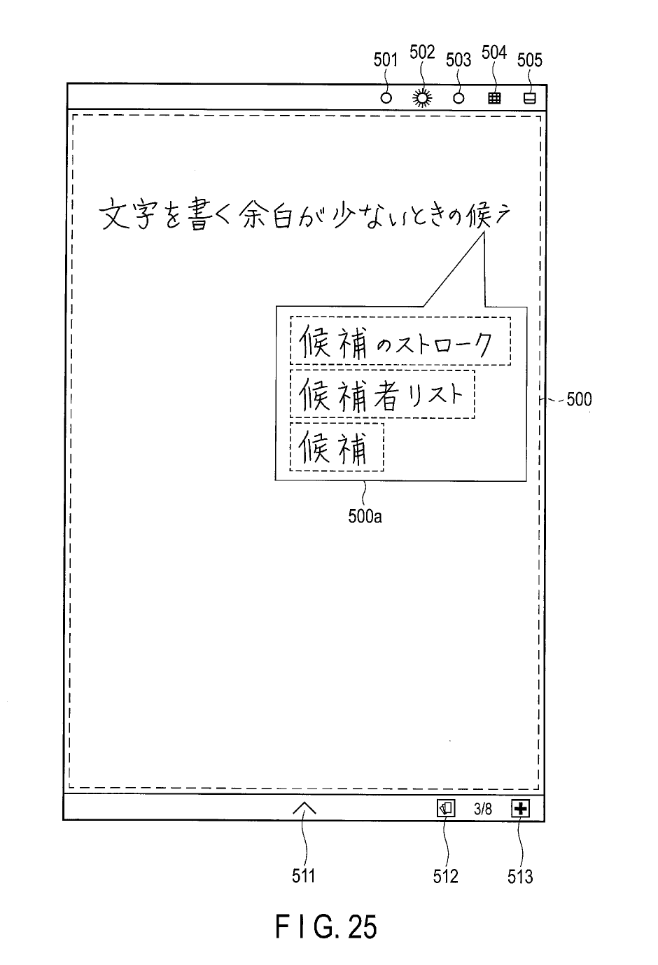

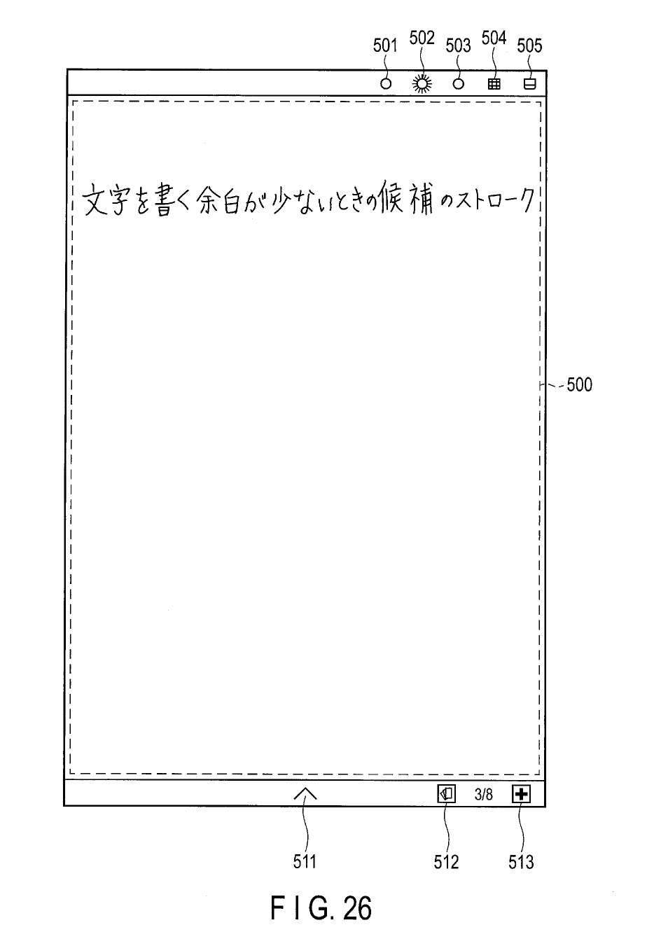

In this example, with reference to FIG. 22 and FIG. 24, a case that a language of the character string handwritten by the user in the handwritten input region 500 is English. FIG. 25 and FIG. 26 show the first display example when the language is Japanese.

In a second display example, a selected character string is divided into different portions and displayed in different regions on a screen. Specifically, in the second display example, a part of a selected character string is displayed on a line different from that of the rest of the selected character string. In this case, a portion that can be displayed in the handwritten input region 500 of the selected character string based on the relative coordinates (hereinafter referred to as the no-line-break portion) is displayed in the handwritten input region 500 on a line same as that of the handwritten character string “XXXXXXX” in the handwritten input region 500. In contrast, for a portion of the selected character string that cannot be displayed in the handwritten input region 500 based on the relative coordinates (hereinafter this portion is referred to as the line-break portion), the relative coordinates of the line-break portion are converted such that the line-break portion is displayed on a line different from that of handwritten character string “XXXXXXX” in the handwritten input region 500.

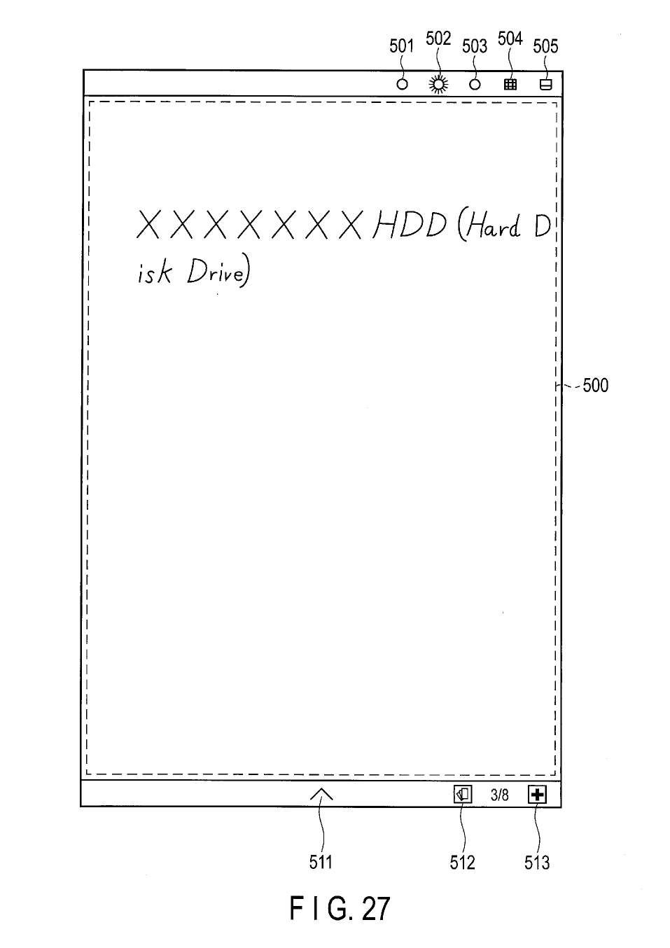

Thus, in the second display example, as shown in FIG. 27, portion “HDD (Hard D” of the selected character string (handwritten character string “HDD (Hard Disk Drive)”) is displayed on a line same as that of handwritten character string “XXXXXXX” and rest “isk Drive” is displayed on a line different from that of handwritten character string “XXXXXXX”.

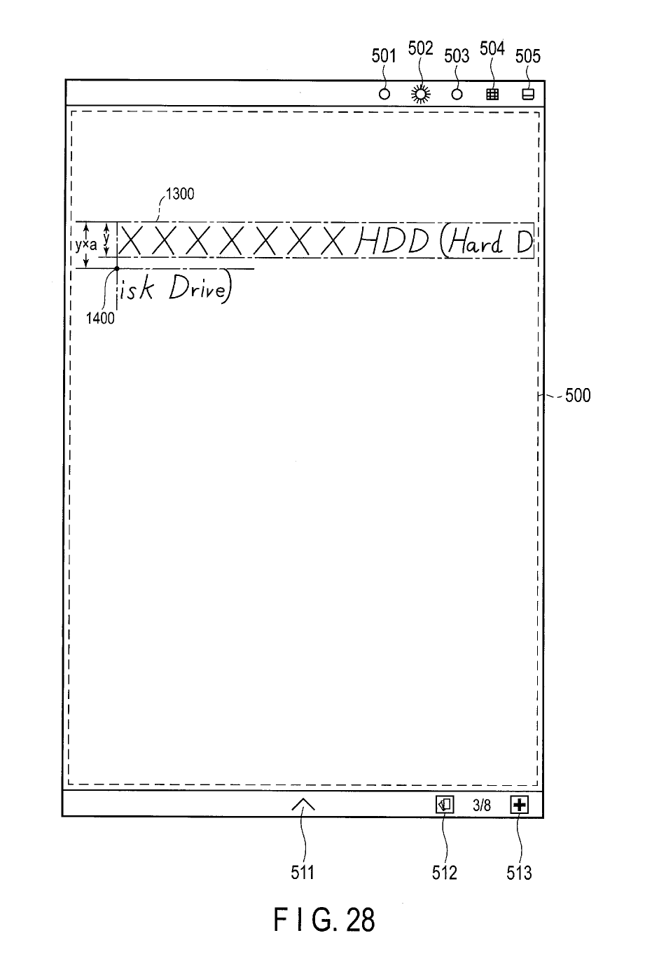

Next, with reference to FIG. 28, a position of a line-break portion in the second display example will be specifically explained.

First, the stroke drawing module 301B calculates a bounding rectangle (coordinates) 1300 of handwritten character strings “XXXXXXX” and “HDD (” in the handwritten input region 500. In this example, the bounding rectangle 1300 represents a line that includes the handwritten character string and the no-line-break portion written in the handwritten input region 500.

Thereafter, as shown in FIG. 28, the stroke drawing module 301B identifies a position 1400 that is below the bounding rectangle 1300, that is lower than an upper side of the bounding rectangle 1300 by y times a, where y is a height of the bounding rectangle 1300 and a is any value greater than 1, for example in a range from 1.2 to 1.5, and that is placed on a line extending from a left side of the bounding rectangle 1300.

The stroke drawing module 301B converts the relative coordinates of the line-break portion (the relative coordinates determined in block B22 shown in FIG. 21) into coordinates relatively defined based on the identified position 1400.

If the line-break portion is displayed in the handwritten input region 500 based on the converted coordinates, the line-break portion can be displayed such that the line-break portion is appropriately kept apart from the line including the handwritten character string and the no-line-break portion and beginning of the line-break portion matches beginning of the handwritten character string.

In this example, the line-break portion is based on the position lower than the upper side of the bounding rectangle 1300 by length y times a. However, if a plurality of lines of a character string has been written in the handwritten input region 500, the display position of the line-break portion may be determined based on a line space.

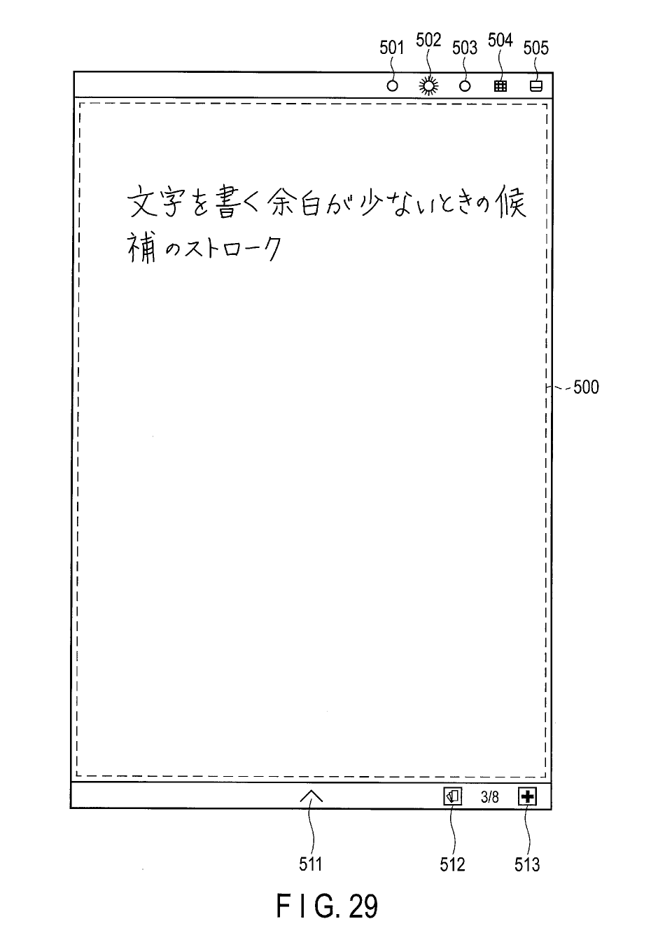

In this example, with reference to FIG. 27, a case that a language of the character string handwritten by the user in the handwritten input region 500 is English. FIG. 29 shows the second display example when the language is Japanese.

Although the third display example is same as the second display example in that a part of a selected character string is displayed on a line different from the rest of the selected character string, the third display example is different from the second display example in that a selected character string is divided into different portions at an end of a word contained in the selected character string. In other words, in the third display example, a part of the selected character string corresponding to a word (first word) contained in the selected character string and a part of another word (second word) contained in the selected character string are displayed in different regions on a screen. In this case, a portion that can be displayed in the handwritten input region 500 of the selected character string based on the relative coordinates (no-line-break portion) is displayed on a line same as that of handwritten character string “XXXXXXX” written in the handwritten input region 500 in the handwritten input region 500 based on the relative coordinates. In contrast, for a portion that cannot be displayed in the handwritten input region 500 of the selected character string based on the relative coordinates (line-break portion), the relative coordinates of the line-break portion are converted such that the line-break portion is displayed on a line different from that of handwritten character string “XXXXXXX” written in the handwritten input region 500.

In the third display example, a selected character string is divided into a no-line-break portion and a line-break portion at an end of a word contained in the selected character string. A word to which each stroke that includes the selected character string belongs can be acquired by processing executed by the feature registration processor 306 or the like. If the language of the selected character string is English, each word of the selected character string can be delimited by a space.

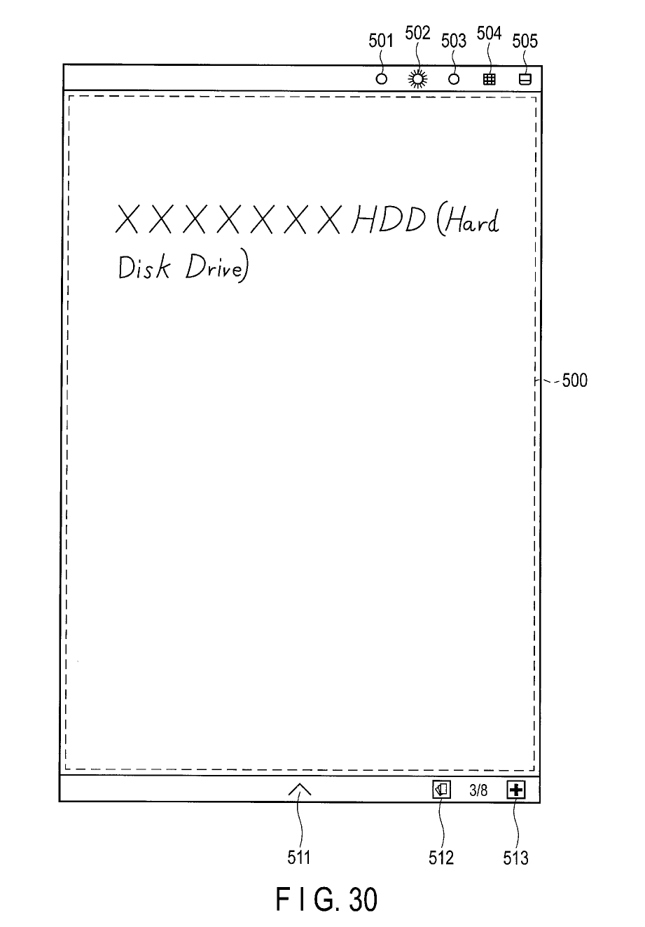

Thus, in the third display example, as shown in FIG. 30, portion “HDD (Hard” of selected character string (handwritten character string “HDD (Hard Disk Drive)”) is displayed on a line same as that of handwritten character string “XXXXXXX”. Portion “Disk Drive)” is displayed on a line different from that of the rest of the handwritten character string. In the third display example, the selected character string is displayed on different lines separated by a space delimited by words.

Since a position at which a line-break portion is displayed is the same as that in the second display example, the detail explanation will be omitted.

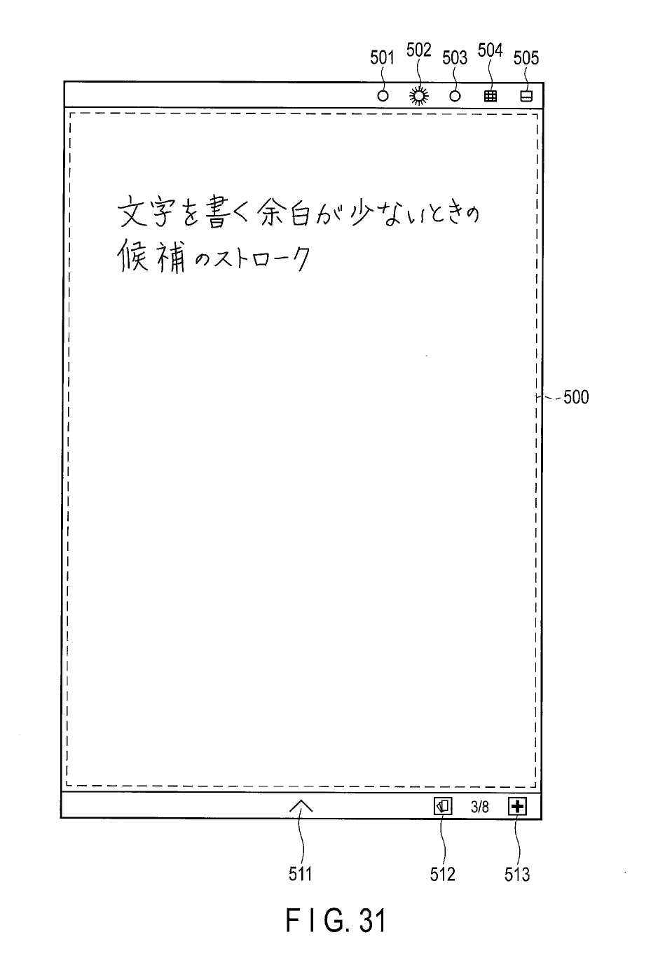

In this example, with reference to FIG. 30, a case that a language of the character string handwritten by the user in the handwritten input region 500 is English. FIG. 31 shows the third display example when the language is Japanese.

Since the first to third display example are mere examples, a selected character string may be displayed in a manner different from the first to third display examples as long as the selected character string is fit to the handwritten input region 500. Moreover, in the first to third display examples, a case that the user handwrites a character string in the horizontal direction is explained. Alternatively, if the user handwrites a character string in a vertical direction, the handwritten character string and a selected character string are displaced in a reduced size. Alternatively, a part of the selected character string may be displayed on a line different from that of the rest of the selected character string and at a position different from the beginning of the selected character string.

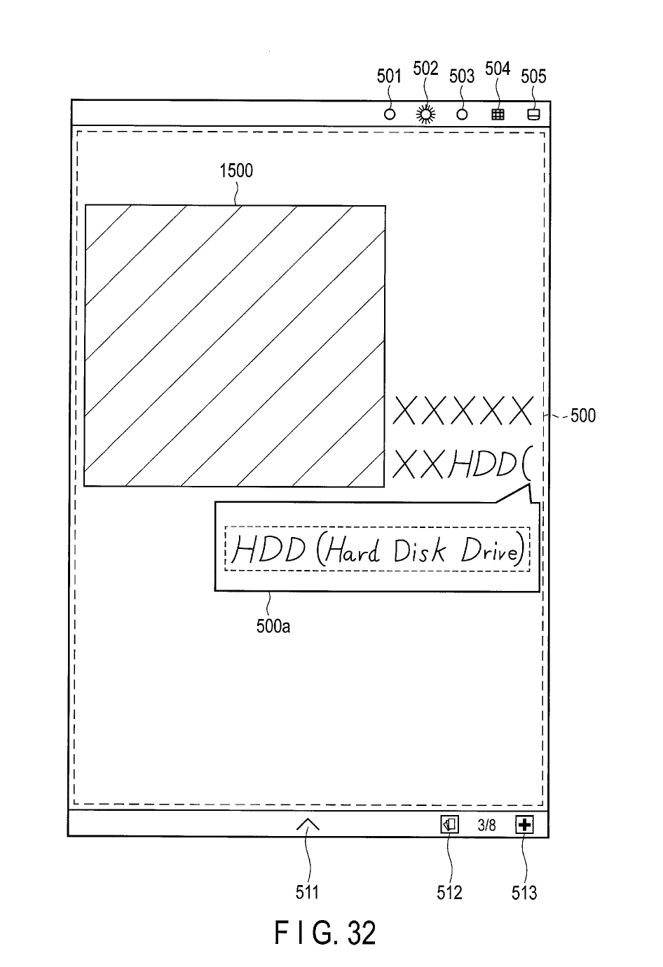

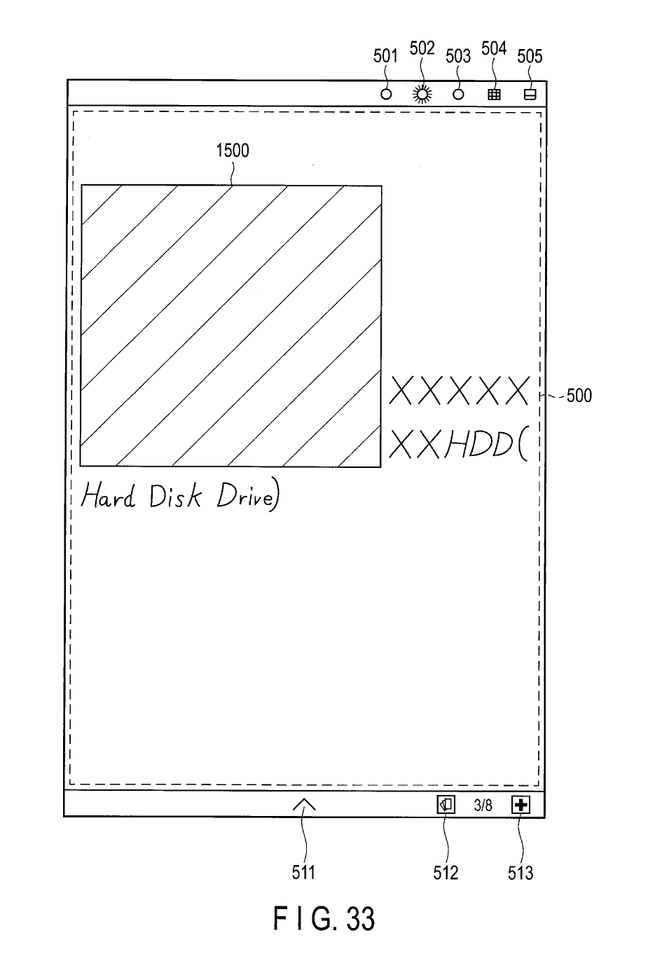

In accordance with the present embodiment, a selected character string is displayed in a region free from other strokes in the handwritten input region 500. Thus, if the user has handwritten a FIG. 1500 or the like in a region on a left side of the handwritten input region 500 as shown in FIG. 32 and has selected a candidate of a character string (handwritten character string “HDD (Hard Disk Drive)”) displayed in the candidate display region 500a, a part of the selected character string (in this example, “Hard Disk Drive)”) is displayed on a line different from that of the rest of the selected character string as shown in FIG. 33.

In FIG. 33, since a region below the FIG. 1500 is blank, a part of a selected character string is displayed from a left end of the handwritten input region 500. Alternatively, the part may be displayed on a line different from that of the rest of the selected character string such that beginning of the part matches beginning of the handwritten character string.

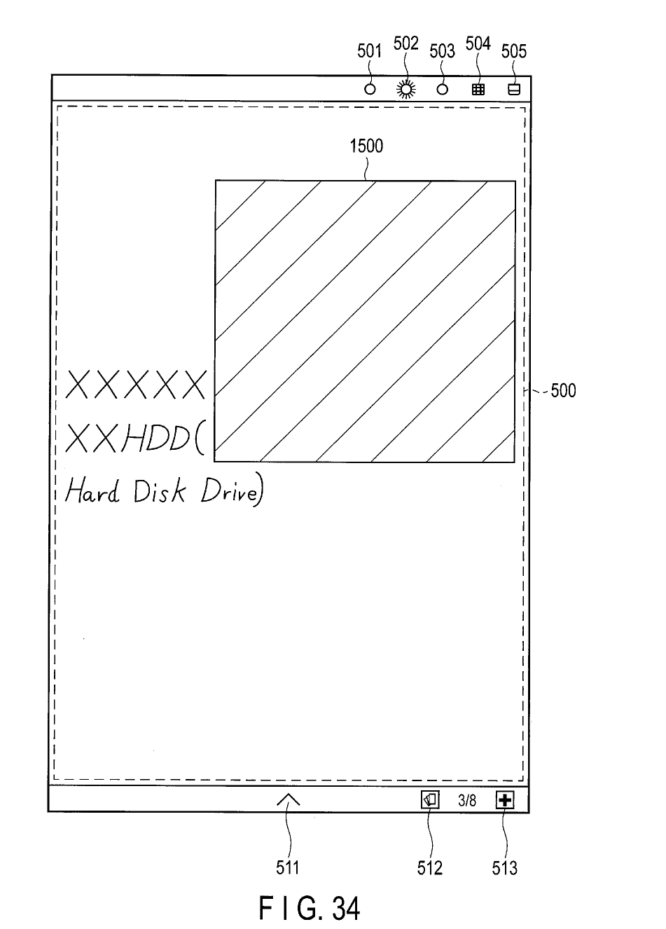

If the user selects a candidate of a character string displayed in the candidate display region 500a shown in FIG. 23, a selected character string may be displayed on a line different from that of the handwritten character string as shown in FIG. 34.

Alternatively, in the second and third display examples, a selected character string may be displayed on a plurality of lines in a space of the handwritten input region 500.

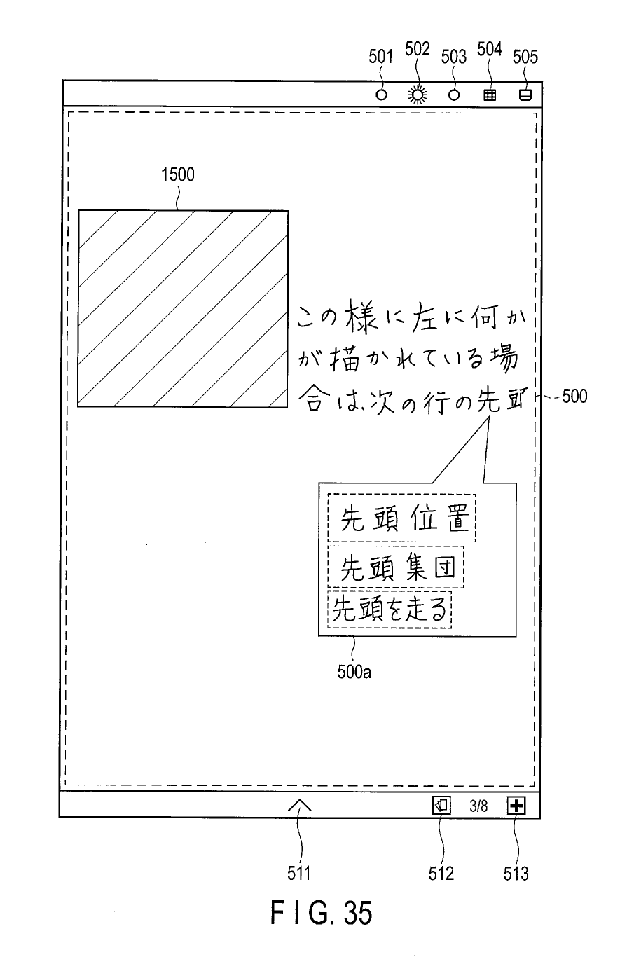

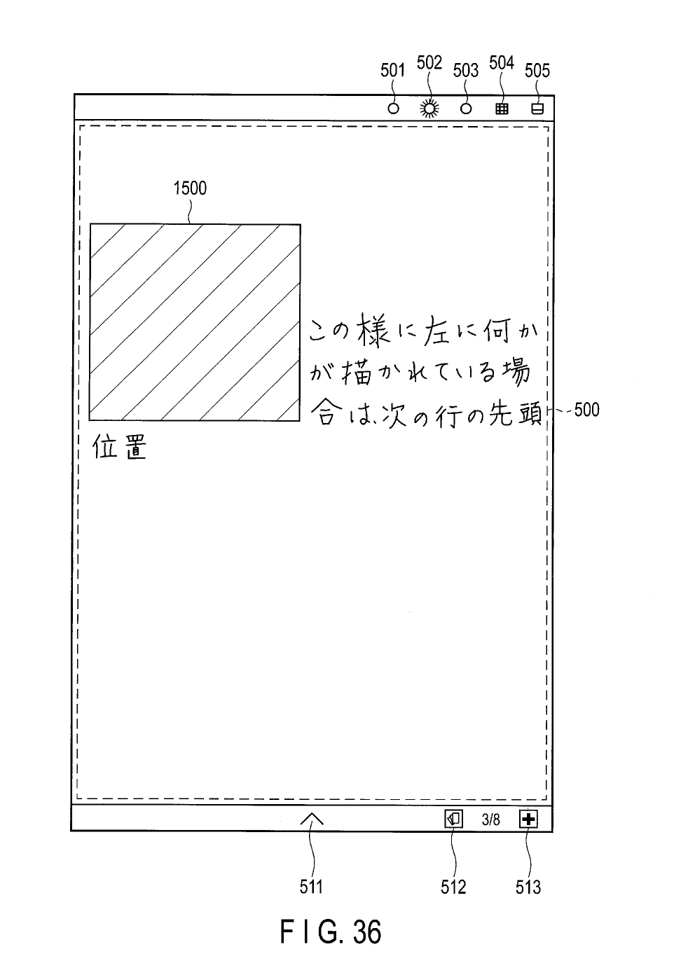

FIG. 35 and FIG. 36 show a display example corresponding to FIG. 32 and FIG. 33 when a language of a character string handwritten by the user in the handwritten input region 500 is Japanese.

In accordance with the present embodiment, if at least one stroke made on a document is received, a handwriting candidate (for example, handwriting “HDD (Hard Disk Drive)”) including a first coordinates in response to a reception of the at least one stroke (for example, “HDD (”) is determined. The first coordinates are determined according to both a shape of the handwriting candidate and an input position of the at least one stroke. The handwriting candidate is displayed on the display of the electronic apparatus. At least part of the first coordinate is converted to generate second coordinates of the handwriting candidate according to an input area of the document. The handwriting candidate is input into the document according to the second coordinates, if the handwriting candidate is selected. As a result, in accordance with the present embodiment, since the user does not need to handwrite all a character string, his or her burden can be lightened. Consequently, the user can easily create a handwritten document.

A region in which the handwriting candidate is displayed is a region in which other strokes are not displayed.

Specifically, in accordance with the present embodiment, if the handwriting candidate cannot be displayed on one line because of the remaining display space (input area) of the document and the display range of the handwriting candidate (namely, the handwriting candidate cannot be displayed in the document), the handwriting candidate is displayed in a reduced size such that the handwriting candidate is fit to the input area of the document. In accordance with the present embodiment, since the handwriting candidate can be displayed in a reduced size, all a character string combined with the handwriting candidate can be displayed on one line.

In addition, in accordance with the present embodiment, a part of a character string combined with the handwriting candidate may be displayed on a line different from that of the rest of the character string. As a result, deterioration of a visibility of the character string that occurs when the handwriting candidate is displayed in a reduced size can be prevented.

In addition, if a part of a character string combined with the candidate is displayed on a line different from that of the rest of the character string, the character string is divided at a space between words contained in the character string combined with the handwriting candidate. Thus, since a word contained in the character string combined with the handwriting candidate is prevented from being divided, the visibility of the character string can be more improved.

In other words, when the handwriting candidate is displayed based on the relative coordinates, even if the input area of the document does not have a space in which the handwriting candidate selected by a user can be displayed, the handwriting candidate (coordinates thereof) can be converted such that the handwriting can be adequately displayed.

The processing in accordance with the present embodiment can be accomplished by a computer program. Thus, if only the computer program is installed to a computer through a computer readable storage medium storing the computer program, effects same as those of the present embodiment can be easily accomplished.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
displaying a document comprising handwriting on a display;
receiving at least one first stroke made on the document;
determining a first handwriting candidate comprising first coordinates in response to a reception of the at least one first stroke, wherein the first coordinates are determined according to both a shape of the first handwriting candidate and an input position of the at least one first stroke;
displaying the first handwriting candidate on the display;
converting at least part of the first coordinate to generate second coordinates of the first handwriting candidate according to an input area of the document; and
inputting the first handwriting candidate into the document according to the second coordinates, if the first handwriting candidate is selected.

2. The method of claim 1,
wherein the converting comprises converting the at least part of the first coordinate to generate the second coordinates according to a stroke contained in a region corresponding to the first coordinates.

3. The method of claim 1,
wherein the converting comprises converting the at least part of the first coordinate to generate the second coordinates according to a positional relationship between the input area of the document and a region corresponding to the first coordinates.

4. The method of claim 1,
wherein the first handwriting candidate is divided into different portions and input in different areas of the document.

5. The method of claim 4,
wherein a character string corresponding to the first handwriting candidate comprises a first word and a second word, and
wherein a part of the first handwriting candidate corresponding to the first word and a part of the first handwriting candidate corresponding to the second word are input in different areas of the document.

6. An electronic apparatus comprising:
a display capable of detecting a stroke on the display and displaying the stroke; and
a hardware processor configured to:
display a document comprising handwriting on the display;
receive at least one first stroke made on the document;
determine a first handwriting candidate comprising first coordinates in response to a reception of the at least one first stroke, wherein the first coordinates are determined according to both a shape of the first handwriting candidate and an input position of the at least one first stroke;
display the first handwriting candidate on the display;
convert at least part of the first coordinate to generate second coordinates of the first handwriting candidate according to an input area of the document; and
input the first handwriting candidate into the document according to the second coordinates, if the first handwriting candidate is selected.

7. The electronic apparatus of claim 6,
wherein the hardware processor is configured to convert the at least part of the first coordinate to generate the second coordinates according to a stroke contained in a region corresponding to the first coordinates.

8. The electronic apparatus of claim 6,
wherein the hardware processor is configured to convert the at least part of the first coordinate to generate the second coordinates according to a positional relationship between the input area of the document and a region corresponding to the first coordinates.

9. The electronic apparatus of claim 6,
wherein the first handwriting candidate is divided into different portions and input in different areas of the document.

10. The electronic apparatus of claim 9,
wherein a character string corresponding to the first handwriting candidate comprises a first word and a second word, and
wherein a part of the first handwriting candidate corresponding to the first word and a part of the first handwriting candidate corresponding to the second word are input in different areas of the document.
